(19) United States
(12) Patent Application Publication
(10) Pub. No.: US 2014/0234579 A1
(43) Pub. Date: Aug. 21, 2014

(54) Composite Preventing Ice Adhesion

(71) Applicants: LIANG WANG, Acworth, GA (US); Viktoria Ren Wang, Acworth, GA (US)

(72) Inventors: LIANG WANG, Acworth, GA (US); Viktoria Ren Wang, Acworth, GA (US)

(21) Appl. No.: 13/767,879

(22) Filed: Feb. 15, 2013

(51) Int. Cl. C09K 3/18; B29C 39/00; B29C 47/00; B44C 1/22; B23K 26/00

(52) U.S. Cl. CPC C09K 3/18; B44C 1/227; B23K 26/0078; B29C 47/003; B29C 39/00
USPC 428/141; 216/58; 264/400; 264/167; 264/293; 264/299; 264/129; 427/290; 427/419.8; 427/407.1; 451/59; 451/38

(57) ABSTRACT

The present invention relates to a novel composite preventing ice adhesion. A plurality of micro-roughened surfaces or organometallized micro-roughened surfaces wetted with a hydrophobic, low freezing-point liquid results in a durable, renewable anti-icing composite. The preparation method for novel icing and rain protecting composite is disclosed.

### CROSS-REFERENCE TO RELATED APPLICATIONS

### U.S Patent Documents

| | | | |
|---|---|---|---|
| U.S. Pat. No. 8,241,508 | Aug. 14, 2012 | D'Urso. Et al | 216/11 |
| U.S. Pat. No. 8,236,379 | Aug. 7, 2012 | Kobrin, et al | 427/ |
| | | | 248.1 |
| U.S. Pat. No. 8,221,847 | Jul. 17, 2012 | Carter | 427/ |
| | | | 407.1 |
| U.S. Pat. No. 8,216,674 | Jul. 10, 2012 | Simpson, et al | 428/403 |
| U.S. Pat. No. 8,211,969 | Jul. 8, 2012 | Zou, et al | 524/496 |
| U.S. Pat. No. 8,202,620 | Jun. 19, 2012 | Simon, et al | 428/442 |
| U.S. Pat. No. 8,202,614 | Jun. 19, 2012 | Koene, et al | 428/403 |
| U.S. Pat. No. 8,193,294 | Jun. 5, 2012 | Hu, et al | 528/31 |
| U.S. Pat. No. 8,187,707 | May 29, 2012 | Van Benthem, et al | 428/403 |
| U.S. Pat. No. 8,153,233 | Apr. 10, 2012 | Sheng, et al. | 428/141 |
| U.S. Pat. No. 8,147,607 | Apr. 3, 2012 | Baumgart, et al | 106/ |
| | | | 287.32 |
| U.S. Pat. No. 8,137,751 | Mar. 20, 2012 | Bhushan, et al | 727/265 |
| U.S. Pat. No. 8,067,059 | Nov. 29, 2011 | Birger, et al | 427/204 |
| U.S. Pat. No. 8,043,654 | Oct. 25, 2011 | Russell, et al | 427/154 |
| U.S. Pat. No. 8,017,234 | Sep. 13, 2011 | Jin, et al | 428/376 |
| U.S. Pat. No. 7,998,554 | Aug. 16, 2011 | Wang, et al | 428/143 |
| U.S. Pat. No. 7.985,475 | Jul. 26, 2011 | Dubrow, et al | 428/359 |
| U.S. Pat. No. 7,985,451 | Jul. 26, 2011 | Luzinov, et al | 427/258 |
| U.S. Pat. No. 7,968,187 | Jun. 28, 2011 | Chinn, et al | 428/339 |
| U.S. Pat. No. 7,943,234 | May 17, 2011 | Lawin, et al | 428/323 |
| U.S. Pat. No. 7,915,371 | Mar. 29, 2011 | Byrd, et al | 528/26 |
| U.S. Pat. No. 7,914,897 | Mar. 29, 2011 | Zimmermann, et al | 428/447 |
| U.S. Pat. No. 7,910,683 | Mar. 22, 2011 | Byrd, et al | 528/26 |
| U.S. Pat. No. 7,897,667 | Mar. 1, 2011 | Mabry, et al | 524/269 |
| U.S. Pat. No. 7,754,279 | Jul. 13, 2010 | Simpson, et al | 427/203 |
| U.S. Pat. No. 7,722,951 | May 25, 2010 | Li, et al | 428/379 |
| U.S. Pat. No. 7,704,608 | Apr. 27, 2010 | Thies, et al | 428/515 |
| U.S. Pat. No. 7,695,767 | Apr. 13, 2010 | Strauss | 427/299 |
| U.S. Pat. No. 7,491,628 | Feb. 17, 2009 | Noca, et al | 438/493 |
| U.S. Pat. No. 7,485,343 | Feb. 3, 2009 | Branson, et al | 427/335 |
| U.S. Pat. No. 7,419,615 | Sep. 2, 2008 | Strauss | 216/83 |
| U.S. Pat. No. 7,261,768 | Aug. 28, 2007 | Luten, et al | 106/ |
| | | | 287.14 |
| U.S. Pat. No. 7,258,731 | Aug. 21, 2007 | D'Urso, et al | 106/2 |
| U.S. Pat. No. 7,253,130 | Aug. 7, 2007 | Chiang, et al | 502/4 |
| U.S. Pat. No. 7,211,605 | May 1, 2007 | Coronado, et al | 516/100 |
| U.S. Pat. No. 7,202,321 | Apr. 1, 2007 | Byrd, et al | 528/26 |
| U.S. Pat. No. 7,150,904 | Dec. 19, 2006 | D'Urso, et al | 428/116 |
| U.S. Pat. No. 6,809,169 | Oct. 26, 2004 | Byrd, et al | 528/28 |
| U.S. Pat. No. 6,797,795 | Sep. 28, 2004 | Byrd | 528/26 |
| U.S. Pat. No. 6,743,467 | Jun. 1, 2004 | Jones, et al | 427/180 |
| U.S. Pat. No. 6,733,892 | May 11, 2004 | Yoneda, et al | 428/447 |
| U.S. Pat. No. 6,702,953 | Mar. 9, 2004 | Simendinger, et al | 252/70 |
| U.S. Pat. No. 6,649,222 | Nov. 18, 2003 | D'Agostino, et al | 427/490 |
| U.S. Pat. No. 6,579,620 | Jun. 17, 2003 | Mizuno, et al | 428/447 |
| U.S. Pat. No. 6,486,245 | Nov. 26, 2002 | Thunemann, et al | 524/130 |
| U.S. Pat. No. 6,432,486 | Aug. 13, 2002 | Paris, et al | 427/447 |
| U.S. Pat. No. 6,395,345 | May 28, 2002 | S.o slashed.rensen | 427/475 |
| U.S. Pat. No. 6,362,135 | Mar. 26, 2002 | Greer | 508/113 |
| U.S. Pat. No. 6,183,872 | Feb. 6, 2001 | Tanaka, et al | 428/429 |
| U.S. Pat. No. 6,153,304 | Nov. 28, 2000 | Smith, et al | 428/447 |
| U.S. Pat. No. 6,114,448 | Sep. 5, 2000 | Derbes | 525/104 |
| U.S. Pat. No. 6,114,446 | Sep. 5, 2000 | Narisawa, et al | 525/104 |
| U.S. Pat. No. 6,084,020 | Jul. 4, 2000 | Smith, et al | 524/501 |
| U.S. Pat. No. 6,068,911 | May 30, 2000 | Shouji, et al | 428/143 |
| U.S. Pat. No. 5,904,959 | May 18, 1999 | Martin | 427/256 |
| U.S. Pat. No. 5,747,561 | May 5, 1998 | Smirnov, et al | 523/212 |
| U.S. Pat. No. 5,736,249 | Apr. 4, 1998 | Smith, et al | 428/447 |
| U.S. Pat. No. 5,565,714 | Jane 21, 1986 | Koshar | 427/515 |
| U.S. Pat. No. 5,336,715 | Aug. 9, 1994 | Seipka, et al | 524/765 |
| U.S. Pat. No. 5,294,252 | Mar. 15, 1994 | Gun | 106/ |
| | | | 287.13 |
| U.S. Pat. No. 5,188,750 | Feb. 23, 1993 | Kogue, et al | 252/70 |
| U.S. Pat. No. 5,187,015 | Feb. 16, 1993 | Yorkgitis, et al | 428/447 |
| U.S. Pat. No. 5.075,378 | Dec. 24, 1991 | Smierciak, et al | 525/109 |
| U.S. Pat. No. 5,045,599 | Sep. 3, 1991 | Murase | 525/102 |
| U.S. Pat. No. 5,008,135 | Apr. 16, 1991 | Giordano, et al | 427/386 |
| U.S. Pat. No. 4,774,112 | Sep. 27, 1988 | Achtenberg, et al | 427/387 |
| U.S. Pat. No. 4,301,208 | Nov. 17, 1981 | Jellinek, et al | 428/334 |
| U.S. Pat. No. 3,931,429 | Jane 6, 1976 | Reick | 428/149 |

### OTHER REFERENCES

[1] Silicon-Containing Polymers: The Science and Technology of Their Synthesis and Applications, Jones, R. G., Ando, W., & Chojnosski, J., Kjuwer Academic Publisher, 2000
[2] Modern Fluoropolymers, High Performance Polymers for Diverse Applications, Scheirs, J., John Wiley & Sons, 1997
[3] Tests of the Performance of Coatings for Low Ice Adhesion, D. N. Anderson, NASA Lewis Research Center, Cleveland Ohio and A.D. Reich, BF Goodrich R&D Center, Brecksville, Ohio, AIAA-97-0303, 35^{th} Aerospace Sciences Meeting & Exhibit, Jan. 6-10, 1997/Reno, Nev.
[4] Anti-icing performance of superhydrophobic surfaces, S. Farhadi, M. Farzaneh and S. A. Kulinich, Appl. Sur. Sci., 257(14) 6264 (2011)
[5] Raster-Elekronenmikroskopie der Epidermis-Oberflachen von Spermatophyten, Barthlott, Wilhelm, Ehler, N. Tropishe and Subtropishe Pflanzenwelt (Akad, Wiss. Lit. Mainz) 19, 110, 1977
[6] Superhydrophobic Surfaces, Carre, A & Mittal, K. L. (2009)
[7] Biomimetics: Bioinspired Hierarchical-Structured Surfaces for Green Science and Technolegy (Biological and Medical Physics, Biomedical Engineering), Bharat Bhushan (2012)
[8] Micro- and Nanostructured Multiphase Polymer Blend Systems: Phase Morphology and Interfaces, Editor: Charef Harrats, Sabu Thomas, Gabriel Groeninckx (2005) CRC Taylor & Trancis,
[9] Phase-Separated Interpenetrating Polymer Networks (Advances in Polymer Science 208) by Yuri S. Lipatov and Tatiana Alekseeva (2010), Springer
[10] Silicon in Organic, Organometallic and Polymer Chemistry, by Micheel, A Brook (1999)

### TECHNICAL FIELD OF THE INVENTION

The present invention relates to a novel composite preventing ice adhesion. A plurality of micro-roughened surfaces or organometallized micro-roughened surfaces wetted with a hydrophobic, low freezing-point liquid results in a durable, renewable anti-icing composite. The preparation method for novel icing and rain protecting composite is disclosed.

### BACKGROUND OF THE INVENTION

A composite for preventing ice adhesion or for facilitating the removal of ice, snow, and frozen contaminants is desirable. The application fields are very broad, encompassing critical areas such as aircraft, vehicles, marine, wind turbine, and electric power cables. For example, in the absence of ice nuclei, supercooled water droplets will remain in the liquid form down to −40° C., such as in stratiform and cumuli clouds. Flying though such clouds, aircraft will seed these droplets, causing abrupt icing on exposed surfaces. In-flight icing causes many tragic accidents.

An anti-icing method with freeze-point depressant solution absorbed by hydrophilic 50% porous polymer matrix are known, such as U.S. Pat. No. 8,221,847 and many others.

Many low surface energy materials, such as silicon-containing polymers [1], fluoropolymers [2] and their composites are claimed as anti-icing coatings, such as: U.S. Pat. No. 8,202,620, U.S. Pat. No. 8,193,294, U.S. Pat. No. 7,897,667, U.S. Pat. No. 7,915,371, U.S. Pat. No. 7,910,683, U.S. Pat. No. 7,261,768, U.S. Pat. No. 7,261,768, U.S. Pat. No. 7,202,321, U.S. Pat. No. 6,809,169, U.S. Pat. No. 6,797,795, U.S. Pat. No. 6,733,892, U.S. Pat. No. 6,579,620, U.S. Pat. No. 6,432,486, U.S. Pat. No. 6,395,345, U.S. Pat. No. 6,363,135, U.S. Pat. No. 6,183,872, U.S. Pat. No. 6,153,304, U.S. Pat. No. 6,114,448, U.S. Pat. No. 6,084,020, U.S. Pat. No. 6,068,911, U.S. Pat. No. 5,904,959, U.S. Pat. No. 5,747,561, U.S. Pat. No. 5,736,249, U.S. Pat. No. 5,336,715, U.S. Pat. No. 5,188,750, U.S. Pat. No. 5,187,015, U.S. Pat. No. 5,075,378, U.S. Pat. No. 5,045,599, U.S. Pat. No. 5,008,135, U.S. Pat. No. 4,565,714, and U.S. Pat. No. 4,301,208.

The NASA Lewis Research Center, which operates the world's largest refrigerated Icing Research Tunnel (IRT), has performed icing research for over 50 years. The studies conducted by NASA and other researchers have concluded that fluoropolymers, siloxane resins, their composites, as surface coatings are inadequate for anti-icing applications [3].

Superhydrophobic nano-micron hierarchical structures of lotus leaves have been studied since 1977 [5]. Various approaches for mimicking the surface topography and surface chemistry of lotus leaves have been attempted, resulting in the launch of biomimetic products [6, 7]. The main methods developed so far have been: 1) layer-by-layer assembly, 2) polymer film roughening, 3) chemical vapor deposition, 4) sol-gel process, 5) phase separation, 6) hydrothermal synthesis, and 7) coating with composites of nanoparticles. The following are typical examples of US patents that are related to superhydrophobic coatings: U.S. Pat. No. 8,241,508, U.S. Pat. No. 8,236,379, U.S. Pat. No. 8,216,674, U.S. Pat. No. 8,211,969, U.S. Pat. No. 8,202,614, U.S. Pat. No. 8,187,707, U.S. Pat. No. 8,153,233, U.S. Pat. No. 8,147,607, U.S. Pat. No. 8,137,751, U.S. Pat. No. 8,067,059, U.S. Pat. No. 8,043,654, U.S. Pat. No. 8,017,234, U.S. Pat. No. 7,998,554, U.S. Pat. No. 7,985,475, U.S. Pat. No. 7,985,451, U.S. Pat. No. 7,968,187, U.S. Pat. No. 7,943,234, U.S. Pat. No. 7,914,897, U.S. Pat. No. 7,754,279, U.S. Pat. No. 7,722,951, U.S. Pat. No. 7,704,608, U.S. Pat. No. 7,695,767, U.S. Pat. No. 7,485,343, U.S. Pat. No. 7,419,615, U.S. Pat. No. 7,291,628, U.S. Pat. No. 7,258,731, U.S. Pat. No. 7,253,130, U.S. Pat. No. 7,211,605, U.S. Pat. No. 7,150,904, U.S. Pat. No. 6,743,467, U.S. Pat. No. 6,649,222, U.S. Pat. No. 3,391,428

However, superhydrophobic surfaces do not always shown low ice adhesion properties. Secondly, anti-icing properties deteriorate by repeated icing/de-icing cycles due to the destruction of very thin and fragile nano/micron hierarchical structures. Thirdly, prolonged exposure to high humidity levels leads to high ice bonding forces due to ice forming in and getting trapped into inter-asperity spaces [4]. Other factors, such as technical complexity of production and scale-up difficulties hinder their application in the real world.

### SUMMARY OF THE INVENTION

Accordingly, the primary objective of this invention is to provide a renewable anti-icing composite which addresses these problems.

Accordingly, the primary objective of this invention is to provide a renewable anti-icing composite which addresses these problems.

A durable, renewable icing protecting composite surface with zero ice adhesion is currently unknown. The present invention relates to a durable renewable anti-icing composite surface with near zero ice adhesion. The novel anti-icing surface repels water, delays ice formation, hindrances ice adhesion, or upon freezing, ice will be easily removed from anti-icing surfaces.

Mechanically durable, easily fabricated, easy scalable, micro-roughened polymer surfaces for anti-icing composite application are currently unknown.

Mechanically durable, easily fabricated, easy scalable, organometallized micro-roughened polymer surfaces for anti-icing composite are currently unknown.

The present invention relates to a composite of novel micro-roughened polymer surfaces having a hydrophobic, low freezing-point liquid wetted onto the asperity surfaces that provides mechanical durability and robustness, renewability, and feasibility for large-area fabrication.

The present invention also relates to a composite of novel organometallized micro-roughened surfaces having a hydrophobic, low freezing-point liquid wetted onto the asperity surfaces that provides mechanical durability and robustness, renewability, and feasibility for large-area fabrication.

A primary objective of the invention is to provide a process method for producing durable, micro-roughened surfaces of polymers by proper surface roughing that is scalable for large-area fabrication of robust anti-icing composites. The micro-roughened polymer or organometallized micro-roughened polymer surfaces with superhydrophobic morphology act as reservoir for hydrophobic, low freezing-point liquids.

Other primary objective of the invention is to provide a simple method for preparation of organometallized layers on micro-roughened polymer surfaces that eliminate polar group influence by polymer molecular materials. Organometallized micro-roughened layers provide the barrier for hindering water affinity and enhancing affinity with hydrophobic, low freezing point liquids. Another main objective of the invention is to select hydrophobic, low freezing-point, low vapor pressure liquids that are suitable for the economic preparation of the novel anti-icing composite.

### DETAILED DESCRIPTION OF THE INVENTION

A durable, renewable icing protection surface with near zero ice adhesion is currently unknown. The present invention relates to a durable renewable anti-icing surface with near zero ice adhesion. The novel anti-icing surface repels water, delays ice formation, hindering ice adhesion, or upon freezing, ice will be easily removed from low ice adhesion surface.

Freezing-point is characteristic temperature at which liquid phase changing into solid phase. Pour-point is the lowest temperature at which liquid will flow. To maintain in a liquid state, it is preferred that the freezing-point or pour-point of candidate hydrophobic liquid for anti-icing application should be lower than application or environmental lowest temperatures, such as −50° C. (223° K). For delay ice formation, reduce ice adhesion, facilitate ice removal, and provide renewable surfaces, it is highly desirable to use a composite to protect icing that comprises of: (1) a low surface energy, hydrophobic liquid having low freezing-point, and (2) a solid surface which has affinity to such hydrophobic liquid.

In the present invention, a water immiscible, hydrophobic liquid with a low freezing-point is essential for the novel composite preventing ice adhesion. The low freezing-point hydrophobic liquid must be non-toxic, and resist chemicals and hydrolysis. Weathering, UV resistant, low vapor pressure, non-flammable or high flash point, and, environmental friendly are desirable.

The hydrophobic, low freezing-point liquids are known: such as poly(diethylsiloxane) (134 K), poly(oxytetrafluoroethylene-co-oxydifluoromethylene) (140 K), low molecular weight polychlorotrifluoroethylene (144 K), polydimethylsiloxane (146 K), and polytrifluoropropylsiloxane (203 K).

Many hydrophobic liquids with a low freezing-point, low surface energy, high flash point, chemical and UV resistant, and environmental friendly are commercially available,

In the present invention, the preferred low freezing-point fluids are: polydiethylsiloxane, poly(oxytetrafluoroethylene-co-oxydifluoromethylene), polydimethylsiloxane, T-branched polydimethylsiloxane, poly(dimethylsiloxane-co-diethylsiloxane), poly(ethylmethylsiloxane), poly(methyltrifluoropropylsiloxane), poly(methyltrifluoropropylsiloxane-co-dimethylsiloxane), perfluoropolyether, polyhexafluoropropylene oxide, perfluoropolyalkyl ether, fluorinated ether, polychlorotrifluoroethylene, polyalphaolefin hydrogenated, and polyalphaolefin.

Silicone fluids, for example polydimethylsiloxanes, polydiethylsiloxanes and methyl T-branched polydimethylsiloxanes are the commercial products with low cost among hydrophobic low freezing point liquids.

Low molecular weight perfluoropolyethers (PFPE) has properties that are ideal for a hydrophobic, low freezing-point liquid. However, PFPE is very expensive.

Other option is fluorinated polysiloxane, such as poly(methyltrifluoropropylsiloxane). However, they are also expensive.

Fluoropolymers have low surface energy and affinity to PFPE [2]. Supercooled water would slide off from PFPE wetted fluoropolymer surface when it is tilted due to low hysteresis and a lack of crystallization centers on PFPE surface. However, PFPE adsorbed on fluoropolymer surfaces suffers weigh loss due to repeated ice removal or rain erosion.

Generally, if water contact angle is greater than 150°, the material is superhydrophobic.

It is known that superhydrophobic properties are based on the Cassie-Baxter state: (1) contact line forces overcome body forces of unsupported water drop weight and (2) hydrophobic microstructures are tall enough to prevent the water that bridges on top of microstructures from touching the base of microstructures.

When a superhydrophobic surface is wetted with a hydrophobic liquid, the inter-asperity spaces of the superhydrophobic morphology provide a reservoir for hydrophobic liquid. The advantage of utilizing superhydrophobic surfaces as a hydrophobic liquid reservoir would be that solid/water contact areas are reduced to a minimum value, therefore, and the amounts of hydrophobic liquid eroded with each icing/ice removal cycles could be minimized.

It is known surface with nano/micro hierarchic roughness can be fabricated with various methods. Treatment on nano/micro hierarchic roughened surfaces with a fluorinated silane or coated with a thin film of perfluorinated polymer that can change it into superhydrophobic surfaces [6, 7]. However, it is well known that superhydrophobic nano/micro hierarchic roughened structures are fragile.

It is unexpected that a simple microroughening method changes a fluorocarbon polymer surface into mechanically durable superhydrophobic surfaces. A preferred fluorocarbon polymer in present invention is a product of homopolymerization or copolymerization of fluoroolefin. The monomer fluoroolefin is selected from the group consisting of tetrafluoroethylene (TFE), hexafluoropropylene (HFP), vinylidene fluoride (VDF), chlorotrifluoroethylene (CTFE), perfluoroalkyl vinyl ether (PAVE), perfluoromethyl vinyl ether, perfluoromethoxyvinyl ether, and a mixture thereof.

The present invention discovered that laser etching, plasma etching, abrasive blasting, sanding with sandpaper, extrusion with surface roughened mould insert, or casting on surface roughened mould provide mechanical durable, micro-roughened surfaces.

It is unexpected that micro-roughened surfaces of fluoroolefin show durable superhydrophobicity. This invention discovered that a composite of PFPE wetted, micro-roughened fluoroolefin polymer shown durable icephobic properties.

Phase separation and Interpenetrating Polymer Network (IPN) are known art [8, 9]. For example, polysiloxane imparts UV and weathering resistance into hybrid polysiloxane/epoxy-polyamine and polysiloxane/acrylic polymer networks, when IPN is utilized to overcome phase separation.

This invention discovered that a novel superhydrophobic surface results from micro-roughening of IPN containing fluoroolefin powder/fluoropolymer blends.

This invention discovered that a novel superhydrophobic surfaces results from micro-roughening of IPN containing fluoroolefin powder/fluorocopolymer blends.

This invention discovered that a composite of PFPE wetted, micro-roughened, IPN containing fluoroolefin powder/fluoropolymer blend shown durable icephobicity against repeated ice removal or rain erosion.

The present invention discovered that simple abrasive blasting, sanding with sandpaper, extrusion with surface roughened mould insert, or casting on surface roughened mould provide mechanical durable, micro-roughened surfaces.

The preferred surface roughening media, sandpaper, or mould surfaces by grit designation is between grit 80 (177-210 microns) to grit 320 (32.5-36 microns), most preferably in about grit 240 (50.0-53.5 microns). The preferred roughening means leading to a surface average roughness (RMS) between 5 to 25 microns, and more preferred in about 12.3-14.5 microns.

It is unexpected that novel micro-roughening method can applied to common polymer materials, such as thermoplastics, thermoset plastics, coatings, paints, fiber reinforced composites, laminated polymers, extruded polymers, casted polymers, injection molding polymers, and reaction injecting molding polymers.

For composite prevent ice adhesion, said plurality of micro-roughened surfaces is resulted from a roughing means being applied on said non-polar, hydrophobic polymer, leading to a preferred surface roughness, and said roughing means is selected from the group consisting of laser etching, plasma etching, oxygen plasma etching, abrasive blasting, sanding with sandpaper, molding, casting, and a mixture thereof.

It is known that silicone fluids have hydrophobicity, low surface energy, low freezing-points, and low vapor pressure. For example, polydimethylsiloxanes, polydiethylsiloxanes, and methyl T-branched polydimethylsiloxanes are the commercial products with low cost among hydrophobic, low freezing-point liquids.

This invention discovered that a composite of silicone fluid wetted micro-roughened, non-polar, hydrophobic polymer surfaces shows icephobic properties.

Broad varieties of non-polar, hydrophobic polymers are commercially available. Those non-polar, hydrophobic polymers can be roughened with preferred roughing method to fabricate micro-roughened surfaces for composite that prevent ice adhesion.

The composite preventing ice adhesion, wherein said material is selected from the group consisting of polymer, polymer blend, polymer networks, interpenetrating polymer networks, coating containing polymer, coating containing polymer blend, coating containing polymer networks, coating containing interpenetrating polymer networks, fiber reinforced polymer, laminated polymer, composite polymer, polymer by injection molding, polymer by casting, polymer by reaction injection molding, and a mixture thereof.

Wherein said polymer in said materials is a hydrophobic non-polar polymer. Said polymer can be selected from the group consisting of polyurethane, fluorinated polyurethane, polyurea, fluorinated polyurea, polysiloxane, high density polyethylene, low density polyethylene, polyethylene, poly(ethylene-co-propylene), polyvinyl chloride, polypropylene, polyethylene terephthalate, acrylonitrile-butadiene-styrene, cyclic olefin copolymer, polyoxymethylene, polyacrylonitrile, polybutadiene, polybutylene, polyvinylidene chloride. polyolefin, polyolefin blend, cycloolefin polymer, poly(ethylene-co-propylene), nature polyisoprene, cis-1,4-polyisoprene, trans-1,4-polyisoprene, synthetic polyisoprene, polybutadiene rubber, chloroprene rubber, neoprene, poly(isobutylene-co-isoprene), chlorobutyl rubber, ethylene propylene rubber, ethylene propylene diene rubber, polypentenamer, polyalkenamer, polyoctenamer, polynorbornene, poly(dicyclopetadiene), polycyclorene rubber, silicone rubber, fluorosilicone rubber, fluoroelastomer, perfluoroelastomer, polypentenomer, alternating rubber, polyolefin blend, oligoethylene, oligopropylene, hydrocarbon resin, and a mixture thereof.

The method of making a composite prevent ice adhesion comprises steps of: (a) providing a polymer; (b) roughening said polymer; (c) applying a hydrophobic, low freezing-point liquid, such as silicone fluid, onto said plurality of micro-roughened surfaces.

In one embodiment of present invention, a composite preventing ice adhesion comprises of: (a) a material having a plurality of micro-roughened surfaces and (b) a low freezing-pint liquid wetting said surfaces.

The composite preventing ice adhesion, wherein said low freezing-point liquid is a hydrophobic fluid selected from the group consisting of poly(pentamethylcyclopentasiloxane), polydiethylsiloxane, poly(oxytetrafluoroethylene-co-oxydifluoromethylene), polydimethylsiloxane, T-branched polydimethylsiloxane, poly(dimethylsiloxane-co-diethylsiloxane), poly(ethylmethylsiloxane), poly(methyltrifluoropropylsiloxane), poly(methyltrifluoropropylsiloxane-co-dimethylsiloxane), perfluoropolyether, polyhexafluoropropylene oxide, perfluoropolyalkyl ether, perfluoroalkyl ether substituted s-triazine, fluorinated ether, polychlorotrifluoroethylene, polyalphaolefin hydrogenated, polyalphaolefin, perfluoroalkyl silsesquioxane, and a mixture thereof.

The composite preventing ice adhesion, wherein said material is selected from the group consisting of polymer, polymer blend, polymer networks, interpenetrating polymer networks, coating containing polymer, coating containing polymer blend, coating containing polymer networks, coating containing interpenetrating polymer networks, fiber reinforced polymer, laminated polymer, composite polymer, polymer by injection molding, polymer by casting, polymer by reaction injection molding, and a mixture thereof.

The composite preventing ice adhesion, wherein said polymer is selected from the group consisting of polyurethane, polyurea, fluorinated polyurethane, fluorinated polyurea, polysiloxane, high density polyethylene, low density polyethylene, polyethylene, polyvinyl chloride, polypropylene, polyethylene terephthalate, acrylonitrile-butadiene-styrene, cyclic olefin copolymer, polyoxymethylene, polyacrylonitrile, polybutadiene, polybutylene, polyvinylidene chloride. polyolefin, polyolefin blend, cycloolefin polymer, poly(ethylene-co-propylene), nature polyisoprene, cis-1,4-polyisoprene, trans-1,4-polyisoprene, synthetic polyisoprene, polybutadiene rubber, chloroprene rubber, Neoprene, poly(isobutylene-co-isoprene), chlorobutyl rubber, ethylene propylene rubber, ethylene propylene diene rubber, polypentenamer, polyalkenamer, polyoctenamer, polynorbornene, poly(dicyclopetadiene), polycyclorene rubber, silicone rubber, fluorosilicone rubber, fluoroelastomer, perfluoroelastomer, polypentenomer, alternating rubber, polyolefin blend, oligoethylene, oligopropylene, hydrocarbon resin, and a mixture thereof.

The composite preventing ice adhesion, wherein said plurality of micro-roughened surfaces is resulted from a roughing means being applied on said material, leading to a preferred surface average roughness (RMS), and said roughing means is selected from the group consisting of laser etching, plasma etching, oxygen plasma etching, blasting with a medium, sanding with a sandpaper, molding with a surface roughened mold, casting on a surface roughened mold, and a mixture thereof.

A method of making a plurality of micro-roughened surfaces, wherein said preferred surface average roughness (RMS) is between 5 to 25 microns, and more preferred in about 12.3-14.5 microns.

A method of making a plurality of micro-roughened surfaces, wherein said medium, said sandpaper, or said surface roughened mold by grit designation is between grit 80 (177-210 microns) to grit 320 (32.5-36 microns), and more preferred in about grit 240 (50.0-53.5 microns).

A method of making a composite preventing ice adhesion comprising steps of: (a) providing said material, (b) roughening said material, and (c) wetting said plurality of micro-roughened surfaces with said low freezing-point liquid.

A hydrophobic liquid fills in the voids between asperities surfaces area of superhydrophobic morphology, liquid replaces air pockets. If water covers on such surface, it contacts on hydrophobic liquid surfaces with great contact area, and touches on the peaks of superhydrophobic microstructures with very small area, the surface properties of such composite would be determined by the hydrophobic liquid.

It is unexpected that a composite of hydrophobic, silicone fluid wetted, polar polymer with superhydrophobic morphology or micro-roughened surface that only shows limited anti-icing properties.

It is known that silicone fluid reduces the adhesion of ice initially, the ice adhesion force increases abruptly with icing/de-icing cycles or on prolonged contacts [3]. Water or its vapor can penetrates through a silicone fluid film and reaches to the silicone fluid covered surface when contact time is prolonged. Water and silicone molecules are competing for adsorption sites on the solid surfaces. A possible solution is to generate a surface layers on polar polymer surface that having affinity with hydrophobic molecules, such as silicone, and blocking affinity between water and polar groups of the polymer.

Functional organometallics, such as reactive organosilicon [10], reactive organotitanate, reactive organozirconate, and reactive organoaluminate are well known for enhance bonding between organic and inorganic as coupling agents. It is known that organometallic coupling agents enhances adhesion of functional organic on inorganic surfaces having metal-hydroxyl groups, such as silica, quarts, glass, ceramics, aluminum, silicon, copper, titanium oxide, and aluminum oxide, etc.

It is unknown, however, organometallic could generate a polymer surface that hindering affinity toward water and enhancing affinity toward silicone or polysiloxane.

An important discovery in this invention is that surface reaction of reactive organometallics with polymer results in organometallized, polymer surface. The organometallized surface hindering affinity toward water and enhance affinity toward hydrophobic liquid, such as silicone fluid, polysiloxane, or alpha-polyolefin.

Reactive organosilicon, organotitanate, organozirconate, and organoaluminate can be used as organometallic reactant to generate organometallized polymer surface.

Reactive organosilicon, such as silane, functional polysiloxane, and functional polysiloxane oligomers are reactive organometallics. The preferred reactive organosilicons are silane, hydrolyzable polysiloxane, mono functional polysiloxane, di-functional polysiloxane, multi-functional polysiloxane, and a mixture thereof. The preferred functional group or groups are in terminal location. The functional species in multi-functional polysiloxane can be same or different. Silanes, called coupling agents, contain two different types of functional groups: 1) silicon bonded hydrolyzable OR groups such as methoxy, ethoxy, or acetoxy group, and 2) silicon bonded organo functional groups such as acryloxy, allyl, amino, alkanolamino, carbinol, carboxy, chloro, epoxy, glycidoxy, halogen, hydroxy, isocyanato, mercapto, methacryloxy, silanol, solfido, and vinyl.

A Si—OR bond hydrolyzes readily with water from moisture or from reaction medium results in a silanol group. Acid or alkali accelerates the hydrolysis. Silane or hydrolyzable siloxane forms silanol containing species following hydrolysis. Silanol functional group can condense (coupling) with surface hydroxyl (OH) group of organic polymers, metal oxides, or other silanol groups of hydrolyzed silanes or siloxanes. Silanol also react with acetoxy, enoxy, oxime, alkoxy, and amine to form siloxane links. Cross-linking reactions of silanol groups are catalyzed by organometallics, such as titanate and tin complex. Silanol groups undergo condensation to form two dimensional (2D) or three dimensional (3D) layered structures of siloxane networks. The silanol condensation, polymeric 2D or 3D siloxane networks, thickness of siloxane networks depend on reactive medium, water content, pH value, substance nature, organic substitutes of silane, temperature, and catalysts. Silanol also undergo dehydrogenetic coupling with hydride function of silane or siloxane. Organometallic complexes, such as organotitanate, organozirconate, organotin, and organozinc catalyze coupling. The selection of silane and polysiloxane is depends on the polymer nature of the micro-roughened surfaces. A siloxane-O—Si—R¹—R²—Si—O-polymer type, organometallized polymer surface has strong affinity toward silicone fluid. For example, to obtain organometallized surface grafted on polyurethane polymer, two step reactions are followed: 1) react a silane having alkanolamino functional group in acidic aqueous alcohol solution with micro-roughened polyurethane surfaces results in a three dimensional siloxane network grafted surfaces, and 2) react a mono epoxycyclohexyl functional polydimethylsiloxane in ketone solution results in organometallized siloxane grafted surfaces on siloxane networks which are directly grafted on polyurethane polymer micro-roughened surfaces. The two step surface organometallization can be performed in a single step. One step surface reactions with a reaction medium containing a mixture of silanes, or a mixture of silane and functional polysiloxane are used. For example, micro-roughened polyurethane polymers react with a pH 5, acidic aqueous ethanol solution containing a mixture of epoxy functional silane and triethoxysilyl functional hydrolyzable polysiloxane.

The reactivity of functional groups of silanes or polysiloxane is following:

The allyl, acryloxy, methacryloxy, styryl and vinyl undergo polymeric addition with unsaturated group on organic polymer surface. The additional polymerization can be initiated by a radical initiator, such as organic peroxide, inorganic peroxide, azo compound, organic redox system, UV, or electron beam.

Radicals extract hydrogen atoms from saturated carbon-carbon bonds and create unsaturated bonds on polymer surface. Therefore, in the presence radical initiator, even saturated polymer surface, such as polyolefin, undergoes additional polymerization grafting with unsaturated reactive silane or polysiloxane. The acrylyl, methacrylyl, and styryl are the most active unsaturated groups. Nitrogen blanket is needed for isolate atmospheric oxygen interference.

Azo compound is a common radical initiator, such as dialkyldiazenes, 2,2′-azobis (methylbutyronitrile), 1,1′-azobis (cyclohexanecarbonitrile), 2,2′-azobis (isobutyronitrile), 2,2′-azobis (2-methylpropionitrile), 4,4′-azobiz(4-cyanovaleric acid), 2,2′-azobis(2,4-dimethyl valeronitrile).

Organic peroxide is the most popular radical initiator. Commercially available organic peroxide compounds are selected from the group consisting of dicumyl peroxide, bis(tert-butyl) peroxide, tert-amyl peroxide, di-benzoyl peroxide, 2,5-dimethyl-2,5-di-tert-butylperoxyhexane, bis(dichlorobenzoyl) peroxide, diacyl peroxide, dialkyl peroxide, dialkylperoxydicarbonate, peroxyester, ketone peroxide, peroxydicarbonate, hydroperoxide, peroxyketal, and a mixture thereof. Amino is a versatile reactive group of organosilicon which can react with many organic groups. For example, amine undergoes Michael additional with acrylate. Amine group reacts with halogen, such as PVC and form imino coupling. Acyl halide or acid anhydride reacts with amine to give amide. Aldehyde and ketone reacts with primary or secondary amine to form imine. Amine reacts with carboxylic acid derivative to give amide. The amino group in aminoalkyl silane or siloxane reacts with an isocyanato group to form a urea link. Amino group reacts with epoxy group to from cross-linking by polyaddition reactions.

Hydride functional organosilicon undergoes catalytic hydrosilylation addition with vinyl functional siloxane when catalyzed by a platinum complex. Hydride functional group undergoes a catalytic dehydrogenetic coupling reaction with silanol to form siloxane chains in the presence of organometallic catalysts. Hydride functional groups reacting with hydroxyl functional silane, atmospheric oxygen, or with a water source will convert to silanol siloxane and these reactions are accelerated by organometallics.

The term carbinol refers to the hydroxyl group bonds to carbon (C—OH) to differentiate them from hydroxyl group bonds to silicon (Si—OH). The carbinol group in hydroxyalkyl siloxane reacts with an isocyanato group to form a stable urethane link. Carbinol also reacts with carboxylic anhydride. Epoxy, such as glycidoxypropyl, epoxycyclohexyl, is versatile reaction groups. Epoxy undergoes cationic ring opening polyaddition activated by active hydrogen to produce new chemical bond and hydroxyl group. Amines, hydroxy acids, anhydrides, Lewis acids, imidazoles and imides are the common active hydrogen reactant. Epoxy also undergoes anionic ring opening, catalytic ring opening, and homopolymerization.

Isocyanato group is very active. It forms urethane with hydroxyl group and forms urea with primary and secondary amines.

For form grafted organometallized micro-roughened polymer surfaces, following functional groups from silane or polysiloxanes are preferred: amine or styryl for diallylphthalate; amine, epoxy, chloroalkyl, or mercapto for epoxy; chloromethylaromatic or amine for imide; amine, epoxy, or alkanolamine for melamine; chloromethylaromatic for paralene; silazane, aromatic, or vinyl for negative photoresist; silazane, aromatic, or phosphine for positive photoresist; amine, methacrylyl, acrylyl, styryl, vinyl, or allyl for polyester; amine, alkanolamine, epoxy, or isocyanate for urethane; amine or isocyanate for cellulosic; thiouronium for polyacetal; methacrylyl, acrylyl, or ureido for polyacrylate; amine or ureido for polyamide (nylon); chloromethylaromatic or amine for polyamide-imide; amine or isocyanate for polybutylene terephthalate; amine for polycarbonate; amine for polyetherketone; ureido for ethylene-vinyl acetate copolymer; amine, vinyl, or styryl for polyethylene; amine or aromatic for polyphenylene oxide; amine, mercapto, or chloromethylaromatic for polyphenylene sulfide; aromatic or styryl for polypropylene; aromatic, epoxy, or vinyl for polystyrene; amine for polysulfone; amine for polyvinyl butyral; amine or alkanolamine for polyvinyl chloride; acrylyl, methacrylyl, styryl, or epoxy for acrylic; mercapto or amine for polysulfide; epoxy for butyl rubber; mercapto for neoprene rubber; mercapto for isoprene rubber; styryl for fluorocarbon elastomer; amine or mercapto for epichlorohydrin; and amine or allyl for silicone rubber.

In present invention for grafting organometallized micro-roughened polymer surfaces, silanes, siloxanes, or polysiloxane that provide reactive functional groups are preferred as reactant. There is hundreds of silanes available. The preferred silanes for the present invention are the following: allyltrimethoxysilane, allyltriethoxysilane, 3-acryloxypropyl trimethoxysilane, 3-aminopropyl triethoxysilane, 3-aminopropyl trimethoxysilane, N-(2-aminoethyl)-3-aminopropyl trimethoxysilane, azidosulfonylhexyl triethoxysilane, 3-chloropropyl triethoxysilane, 3-chloropropyl trimethoxysilane, N-cyclohexylaminopropyl trimethoxysilane, 3-glycidopropyl trimethoxysilane, 2-(3,4-epoxycyclohexyl)ethyl trimethoxysilane, 2-(3,4-epoxycyclohexyl)ethyl trimethoxysilane, (3-glycydoxypropyl) triethoxysilane, (3-glycydoxypropyl) trimethoxysilane, 3-isocyanatopropyl triethoxysilane, 3-isocyanatopropyl trimethoxysilane, 3-methacryloxypropyl trimethoxysilane, N-methylaminopropyl trimethoxysilane, 3-mercaptopropyl trimethoxysilane, 3-thioisocyanatopropyl trimethoxysilane, bis-[3-(triethoxysilyl)propyl]tetrasulfide, 3-(triethoxysilyl)propyl succinic anhydride, ureidopropyl triethoxysilane, ureidopropyl trimethoxysilane, vinyltriacetoxysilane, vinyltriethoxysilane, and vinyltrimethoxysilane.

Following compounds are example of useful organotitanate in present invention: titanium di-n-butoxide (bis-2,4-pentanedionate), titanium diisopropoxide (bis-2,4-pentanedionate), titanium diisopropoxide bis(ethylacetoacetate), titanium (bis-2,4-pentanedionate), titanium (bis-2,4-pentanedionate), titanium 2-ethylhexoxide, and titanium trimethylsiloxide.

Following compounds are example of useful organozirconate in present invention: zirconium tetrakis(2,4-pentanedionate) complex and dialkylzirconium dionate,

Following compound is the example of useful organoaluminate in present invention: aluminum dionate, aluminum tris(2,4-pentanedionate) complex.

Following polysiloxanes are example of useful reactive polysiloxanes in present invention: such as siloxane having acetoxy, acryloxy, allyl, amino, alkanolamino, alkoxy, carbinol, epoxy, hydride, isocyanato, methacryloxy, silanol, or vinyl.

There are hundreds of functional siloxane polymers/oligomers available. Preferred functional polysiloxanes include monofunctional polysiloxane, di-functional polysiloxanes, and multifunctional polysiloxanes. The preferred functional group or groups of polysiloxane is in terminal location. Hydrolyzable polydimethylsiloxane is a class of preferred functional polysiloxanes. Hydrolyzable polysiloxanes have hydrolyzable functionality. They react with water to produce silanol groups. Hydrolyzable polysiloxanes can be mono-functional, di-functional, or multi-functional. Follows are preferred hydrolyzable reactive polysiloxane in present invention: chlorine terminated polydimethylsiloxane, triacetoxysilyl terminated polydimethylsiloxane, triethoxysilyl terminated polydimethylsiloxane, diethoxysilyl terminated polydimethylsiloxane; ethoxysilyl terminated polydimethylsiloxane, trimethoxysilyl terminated polydimethylsiloxane, dimethoxysilyl terminated polydimethylsiloxane, and methoxysilyl terminated polydimethylsiloxane. Monofunctional terminated polysiloxanes having various reactive functional groups and high molecular weights are preferred. There are two classes of mono functional polysiloxanes: asymmetric and symmetric. In present invention, following mono functional polysiloxanes are preferred: Asymmetric mono aminopropyl terminated polydimethylsiloxane; Asymmetric mono carbinol hydroxyethoxy terminated polydimethylsiloxane; Symmetric mono carbinol hydroxypoly(ethyleneoxy)propyl functional polydimethylsiloxane; Asymmetric mono dicarbinol terminated polydimethylsiloxane; Symmetric mono carboxy functional polydimethylsiloxane; Asymmetric, mono (2,3-epoxy) propylether terminated polydimethylsiloxane; Symmetric mono (2,3-epoxy)propylether functional polydimethylsiloxane; Asymmetric mono hydride terminated polydimethylsiloxane Asymmetric mono methacryloxypropyl terminated polydimethylsiloxane; Symmetric mono methacryloxypropyl functional polydimethylsiloxane; Symmetric mono methacryloxypropyl functional poly(trifluoropropylmethyl)siloxane; Asymmetric mono vinyl terminated polydimethylsiloxane, and symmetric mono vinyl functional polydimethylsiloxane.

In present invention alpha-, omega-, terminated di-functional, and pendant functional polysiloxane are among the preferred reactive polysiloxanes: Vinyl terminated polydimethylsiloxane; Vinyl terminated polydiethylsiloxane; Vinylmethylsiloxane-dimethylsiloxane copolymer; Poly(vinylmethylsiloxane) homopolymer; Hydride terminated poly(methylhydrosiloxane); Trimethylsiloxy terminated methylhydrosiloxane-dimethylsiloxane copolymer; Trimethylsiloxy terminated polymethylhydrosiloxane; Silanol terminated polydimethylsiloxane; Silanol terminated polytrifluoropropylmethylsiloxane; Hydroxypropyl terminated polydimethylsiloxanes; Hydroxyethyoxypropyl terminated polydimethylsiloxane; Hydroxyhexyl terminated polydimethylsiloxane; Hydroxybutyl terminated polydimethylsiloxane Hydroxyhexyl terminated polydimethylsiloxane. Aminopropyl terminated polydimethylsiloxanes; Aminohexyl terminated polydimethylsiloxane; Alpha, omega-di[(N-ethyl)amino(2-methyl)propyl]polydimethylsiloxane; Alpha, omega-di[(N-methyl)amino(2-methyl)propyl]polydimethylsiloxane. Epoxypropoxypropyl terminated polydimethylsiloxanes; (Epoxypropoxypropyl methylsiloxane)-dimethylsiloxane copolymer; (Epoxycyclohexylmethylsiloxane)-dimethylsiloxane copolymer; Epoxycyclohexylethyl terminated polydimethylsiloxane; Hydroxypropyl terminated polydimethylsiloxanes; Methacryloxypropyl terminated polydimethylsiloxane; 3-Acryloxy-2-hydroxypropoxypropyl terminated polydimethylsiloxane; Acryloxypropylmethylsiloxane-dimethylsiloxane copolymer; Succinic anhydride terminated polydimethylsiloxane; Carboxyalkyl terminated polydimethylsiloxane. Mercaptopropylmethylsiloxane-dimethylsiloxane copolymer having; Chloromethyl terminated polydimethylsiloxane; and chloropropylmethylsiloxane-dimethylsiloxane copolymer.

For conducting surface reaction between an organometallic reactant and micro-roughened polymer surfaces, a reaction medium is required. A useful reaction medium for surface organometallization in present invention can be selected from the group consisting of water, aqueous alcohol, alcohol, ketones, esters, tetrahydrofuran, N,N-dimethylformamide, N,N-dimethylacetamide, 1-methyl-2-pyrrolidone, dimethyl sulfoxide, xylene, hydrocarbon solvents, and a mixture thereof.

The useful concentration of reactive organometallics in reaction medium is between 0.001 to 5%, and more preferred, between 0.1 to 1%. The suitable concentration can be calculated by desirable multi-layer thickness and the surface area of micro-roughened polymers. Hydrolysis of organometallics requires water. Water can be obtained by water addition, moisture in atmosphere, and exist water concentration in solvents. A typical reaction medium for silane hydrolysis is pH 5-6 for acidic and pH 8-9 for basic. The pH of reaction medium can be adjusted by addition of mild acid, mild alkaline, or by buffer solution. Acetic acid-acetate, succinic acid-succinate, phosphate, EDTA, borax, borate, HEPES, oxalic acid-oxalate, bicarbonate provide amine-free buffer solution in aqueous solvent and aqueous alcohol medium. The type of polymers, reactive organometallics, and desirable organometallized layers determine the reaction temperature. Most organometallization of micro-roughened organic polymer can be processed under ambient temperature. Elevated temperature, higher concentration of organometallics is required if polymer is inertial, and functional group of organometallics is not active.

An important discovery of present invention is that a composite of silicone fluid wetted polar polymer with organometallized, micro-roughened surfaces providing icephobic properties. It is unexpected that their icephobic properties do not shown noticeable decrease with repeated icing/ice removal cycles.

Therefore, applicable polymer varieties become much greater. It covers all hydrophobic polymers. Broad varieties of hydrophobic polymers are commercially available. Those hydrophobic polymers can be fabricated with preferred roughing method to fabricate micro roughened surfaces for composite that prevent ice adhesion. For example, preferred hydrophobic polymer are as followings: polyurethane, polyurea, fluorinated polyurethane, fluorinated polyurea, polysiloxane, interpenetrating polymer network material, high density polyethylene, low density polyethylene, polyethylene, polyvinyl chloride, polypropylene, polyethylene terephthalate, polymethylmethacrylate, polycarbonate, acrylonitrile-butadiene-styrene, polyamide, polyimide, polysulfone, polyamide-imide, polyetherimide, polyether ether ketone, polyaryletherketone, cyclic olefin copolymer, ethylene-vinyl acetate, polyoxymethylene, polyacrylate, polyacrylonitrile, polybutadiene, polybutylene, polycaprolactone, polyester, polyvinylidene chloride. polyolefin, polyolefin blend, cycloolefin polymer, poly(ethylene-co-propylene), polybutylene-terephthalate, polyvinyl acetate, polyacrylethersulphone, liquid crystal polymer, polyurea elastomer, polyurethane elastomer, nature polyisoprene, cis-1,4-polyisoprene, trans-1,4-polyisoprene, synthetic polyisoprene, polybutadiene rubber, chloroprene rubber, Neoprene, poly(isobutylene-co-isoprene), chlorobutyl rubber, nitrile rubber, epoxide rubber, hydrogenated nitrile rubber, ethylene propylene rubber, ethylene propylene diene rubber, epichlorohydrin rubber, polyacrylic rubber, polypentenamer, polyalkenamer, polyoctenamer, polynorbornene, poly(dicyclopetadiene), polycyclorene rubber, butadiene-acrylonitrile rubber, silicone rubber, polyether block amide, chlorosulfonated polyethylene, polysulfide rubber, fluorosilicone rubber, fluoroelastomer, perfluoroelastomer, Tiokol, polypentenomer, alternating rubber, polyether ester, polyolefin blend, elastomeric alloy (TPE-v, TPV), thermoplastic polyurethane, thermoplastic copolyester, thermoplastic polyamide, radiation curing, electron beam curing, oligoethylene, oligopropylene, hydrocarbon resin, oligoether, oligoester, polyvinyl acetal, polyvinyl ketone, polylactic acid, and polyisocyanate.

In one embodiment of present invention, a composite preventing ice adhesion comprises of: (a) a material having a plurality of micro-roughened surfaces, (b) a plurality of organometallized layers grafted on said surfaces, and (c) a low freezing-pint liquid wetting said layers.

The composite preventing ice adhesion, wherein said low freezing-point liquid is a hydrophobic fluid selected from the group consisting of poly(pentamethylcyclopentasiloxane), polydiethylsiloxane, poly(oxytetrafluoroethylene-co-oxydifluoromethylene), polydimethylsiloxane, T-branched polydimethylsiloxane, poly(dimethylsiloxane-co-diethylsiloxane), poly(ethylmethylsiloxane), poly(methyltrifluoropropylsiloxane), poly(methyltrifluoropropylsiloxane-co-dimethylsiloxane), perfluoropolyether, polyhexafluoropropylene oxide, perfluoropolyalkyl ether, perfluoroalkyl ether substituted s-triazine, fluorinated ether, polychlorotrifluoroethylene, polyalphaolefin hydrogenated, polyalphaolefin, perfluoroalkyl silsesquioxane, and a mixture thereof.

The composite preventing ice adhesion, wherein said material is selected from the group consisting of polymer, polymer blend, polymer networks, interpenetrating polymer networks, coating containing polymer, coating containing polymer blend, coating containing polymer networks, coating containing interpenetrating polymer networks, fiber reinforced polymer, laminated polymer, composite polymer, polymer by injection molding, polymer by reaction injection molding, polymer by casting, and a mixture thereof.

The material for the composite preventing ice adhesion, where said polymer is selected from the group consisting of polyurethane, polyurea, fluorinated polyurethane, fluorinated polyurea, polyvinyl chloride, chlorinated polyvinyl chloride, polyethylene terephthalate, polymethylmethacrylate, polycarbonate, acrylonitrile-butadiene-styrene, polyamide, polyimide, polysulfone, polyamide-imide, polyetherimide, polyether ether ketone, polyaryletherketone, ethylene-vinyl acetate, polyoxymethylene, polyacrylate, cycloaliphatic epoxy, aliphatic epoxy acrylic, hybrid aliphatic epoxy, polyacrylonitrile, polybutadiene, polybutylene, polycaprolactone, polyester, polyvinylidene chloride. polybutylene-terephthalate, polyvinyl acetate, polyacrylethersulphone, liquid crystal polymer, oligoether, oligoester, polyurea elastomer, polyurethane elastomer, nature polyisoprene, cis-1,4-polyisoprene, trans-1,4-polyisoprene, synthetic polyisoprene, polybutadiene rubber, chloroprene rubber, neoprene, poly(isobutylene-co-isoprene), chlorobutyl rubber, nitrile rubber, epoxide rubber, hydrogenated nitrile rubber, ethylene propylene diene rubber, epichlorohydrin rubber, polyacrylic rubber, polypentenamer, polyalkenamer, polyoctenamer, polynorbornene, poly(dicyclopetadiene), polycyclorene rubber, butadiene-acrylonitrile rubber, silicone rubber, polyether block amide, chlorosulfonated polyethylene, polysulfide rubber, fluorosilicone rubber, fluoroelastomer, perfluoroelastomer, Tiokol, polypentenomer, alternating rubber, polyether ester, elastomeric alloy (TPE-v, TPV), thermoplastic polyurethane, thermoplastic copolyester, thermoplastic polyamide, radiation curing, electron beam curing, polyvinyl acetal, polyvinyl ketone, alkyd, polylactic acid, polyisocyanate, and a mixture thereof.

The composite preventing ice adhesion, wherein said plurality of micro-roughened surfaces is resulted from a roughing means being applied on said material, leading to a preferred surface average roughness (RMS), and said roughing means is selected from the group consisting of laser etching, plasma etching, oxygen plasma etching, blasting with a medium, sanding with a sandpaper, extrusion with a surface roughened mold, molding with a surface roughened mold, casting on a surface roughened mold, and a mixture thereof.

A method of making a plurality of micro-roughened surfaces, wherein said preferred surface average roughness (RMS) is between 5 to 25 microns, and more preferred in about 12.3-14.5 microns.

A method of making a plurality of micro-roughened surfaces, wherein said medium, said sandpaper, or said surface roughened mold by grit designation is between grit 80 (177-210 microns) to grit 320 (32.5-36 microns), and more preferred in about grit 240 (50.0-53.5 microns).

The composite preventing ice adhesion, wherein said plurality of organometallized layers is resulted in a surface reaction between a reactive organometallics and said material on said plurality of micro-roughened surfaces, and said reactive organometallics is selected from the group consisting of reactive silane, reactive polysiloxane, organotitanate, organozirconate, organoaluminate, and a mixture thereof.

The composite preventing ice adhesion, wherein said reactive silane is selected from the group consisting of allyltrimethoxysilane, allyltriethoxysilane, 3-acryloxypropyl trimethoxysilane, 3-aminopropyl triethoxysilane, 3-aminopropyl trimethoxysilane, 4-aminobutyl triethoxysilane, 3-aminopropyl tris(methoxyethoxyethoxy)silane, 11-amino-undecyl triethoxysilane, 3-aminopropylmethyl dimethoxysilane, 3-aminopropyldiisopropyl ethoxysilane, N-(2-aminoethyl)-3-aminopropyl trimethoxysilane, 1,2-bis[(trimethoxysilyl)propyl]ethylenediamine, azidosulfonylhexyl triethoxysilane, bis(trimethoxysilyl) octane, bis(trimethoxysilylpropyl)amine, N-butylaminopropyl trimethoxysilane, 3-chloropropyl triethoxysilane, 3-chloropropyl trimethoxysilane, N-cyclohexylaminopropyl trimethoxysilane, N-ethylaminoisobutyl trimethoxysilane, 3-glycidopropyl trimethoxysilane, 2-(3,4-epoxycyclohexyl)ethyl trimethoxysilane, 2-(3,4-epoxycyclohexyl)ethyl trimethoxysilane, (3-glycydoxypropyl) triethoxysilane, (3-glycydoxypropyl) trimethoxysilane, hexenyltriethoxysilane, N-(hydroxyethyl)-N-methylaminopropyl trimethoxysilane, bis(2-hydroxyethyl)-3-aminopropyl triethoxysilane, 3-hydroxypropyl trimethoxysilane, 3-isocyanatopropyl triethoxysilane, 3-isocyanatopropyl trimethoxysilane, 3-methacryloxypropyl trimethoxysilane, N-methylaminopropyl trimethoxysilane, 3-mercaptopropyl trimethoxysilane, 3-thioisocyanatopropyl trimethoxysilane, bis(triethoxysilyl)ethane, bis-(trimethoxysilylpropyl)amine, bis[3-(triethoxysilyl)propyl]tetrasulfide, bis(trimethoxysilylpropyl)amine, 3-(triethoxysilyl)propyl succinic anhydride, ureidopropyl triethoxysilane, ureidopropyl trimethoxysilane, vinyltriacetoxysilane, vinyltriethoxysilane, and vinyltrimethoxysilane.

The composite preventing ice adhesion, wherein said reactive polysiloxane is a hydrolyzable polysiloxane, said hydrolyzable polysiloxane is selected from the group consisting of chlorine terminated polydimethylsiloxane, triacetoxysilyl terminated polydimethylsiloxane, triethoxysilyl terminated polydimethylsiloxane, diethoxysilyl terminated polydimethylsiloxane; ethoxysilyl terminated polydimethylsiloxane, trimethoxysilyl terminated polydimethylsiloxane, dimethoxysilyl terminated polydimethylsiloxane, methoxy terminated polydimethylsiloxane, and a mixture thereof. The composite preventing ice adhesion, wherein said reactive polysiloxane is a mono functional polysiloxane, said mono functional polysiloxane is selected from the group consisting asymmetric chlorine terminated polydimethylsiloxane, asymmetric triacetoxysilyl terminated polydimethylsiloxane, asymmetric triethoxysilyl terminated polydimethylsiloxane, asymmetric diethoxymethylsilyl terminated polydimethylsiloxane; asymmetric ethoxydimethylsilyl terminated polydimethylsiloxane, asymmetric trimethoxysilyl terminated polydimethylsiloxane, asymmetric dimethoxymethylsilyl terminated polydimethylsiloxane, asymmetric methoxydimethylsilyl terminated polydimethylsiloxane, mono aminopropyl terminated polydimethylsiloxane, asymmetric mono carbinol hydroxyethoxy terminated polydimethylsiloxane, symmetric mono carbinol hydroxypoly(ethyleneoxy)propyl functional polydimethylsiloxane, asymmetric mono dicarbinol terminated polydimethylsiloxane, symmetric mono carboxy functional polydimethylsiloxane, asymmetric, mono (2,3-epoxy) propylether terminated polydimethylsiloxane, symmetric mono (2,3-epoxy)propylether functional polydimethylsiloxane, asymmetric mono hydride terminated polydimethylsiloxane, asymmetric mono methacryloxypropyl terminated polydimethylsiloxane, symmetric mono methacryloxypropyl functional polydimethylsiloxane, symmetric mono methacryloxypropyl functional poly(trifluoropropylmethyl)siloxane, asymmetric mono vinyl terminated polydimethylsiloxane, symmetric mono vinyl functional polydimethylsiloxane, and a mixture thereof.

The composite preventing ice adhesion, wherein said reactive polysiloxane is a multi-functional terminated polysiloxane, said multi-functional terminated polysiloxane is selected from the group consisting of chlorine terminated polydimethylsiloxane, triacetoxysilyl terminated polydimethylsiloxane, triethoxysilyl terminated polydimethylsiloxane, diethoxysilyl terminated polydimethylsiloxane, ethoxysilyl terminated polydimethylsiloxane, trimethoxysilyl terminated polydimethylsiloxane, dimethoxysilyl terminated polydimethylsiloxane, methoxysilyl terminated polydimethylsiloxane, vinyl terminated polydimethylsiloxane, vinyl terminated polydiethylsiloxane, vinylmethylsiloxane-dimethylsiloxane copolymer, poly(vinylmethylsiloxane) homopolymer, hydride terminated poly(methylhydrosiloxane), trimethylsiloxy terminated methylhydrosiloxane-dimethylsiloxane copolymer, trimethylsiloxy terminated polymethylhydrosiloxane, silanol terminated polydimethylsiloxane, silanol terminated polytrifluoropropylmethylsiloxane; hydroxypropyl terminated polydimethylsiloxanes, hydroxyethyoxypropyl terminated polydimethylsiloxane, hydroxyhexyl terminated polydimethylsiloxane, hydroxybutyl terminated polydimethylsiloxane, hydroxyhexyl terminated polydimethylsiloxane, aminopropyl terminated polydimethylsiloxanes, aminohexyl terminated polydimethylsiloxane, alpha, omega-di[(N-ethyl)amino(2-methyl)propyl]polydimethylsiloxane, alpha, omega-di[(N-methyl)amino(2-methyl)propyl]polydimethylsiloxane, epoxypropoxypropyl terminated polydimethylsiloxanes, (epoxypropoxypropyl methylsiloxane)-dimethylsiloxane copolymer, (epoxycyclohexylmethylsiloxane)-dimethylsiloxane copolymer, epoxycyclohexylethyl terminated polydimethylsiloxane, methacryloxypropyl terminated polydimethylsiloxane, 3-acryloxy-2-hydroxypropoxypropyl terminated polydimethylsiloxane, acryloxypropylmethylsiloxane-dimethylsiloxane copolymer, succinic anhydride terminated polydimethylsiloxane, carboxyalkyl terminated polydimethylsiloxane, mercaptopropylmethylsiloxane-dimethylsiloxane copolymer having, chloromethyl terminated polydimethylsiloxane, chloropropylmethylsiloxane-dimethylsiloxane copolymer, and a mixture thereof.

The method of making a composite comprises steps of: (a) providing said material; (b) roughening said material; (c) conducting said surface reaction, and (d) wetting said plurality of organometallized surface layers with said low freezing-point liquid.

The novel composite for preventing ice adhesion shows that their icephobic properties does not show noticeable decrease with repeated icing/ice removal cycles.

It is unexpected that ice splits apart easily from the surface of novel anti-icing composite upon water freezing on such surfaces.

The present invention discovered that the novel anti-icing composite shows near zero ice adhesion or high anti-icing ability as measured by the force necessary for ice removal per unit of surface area. Since certain anti-icing applications for aircraft, wind turbines, high voltage electric power lines, and marine structures require long-term resistance toward UV and weathering, it is highly desirable to utilize aliphatic polymers, fluorine-containing polymers because they are UV and weathering resistant. Since certain anti-icing applications for aircraft, helicopters, and wind turbines require long-term resistance toward rain and sand erosion, it is highly desirable to utilize elastomeric polyurethane coating because it is shown resistance toward rain and sand erosion. Polyurethane is an important material for coating, paint, elastomer, casting, extrusion, molding, and reaction injection molding applications. The reaction between an isocyanato (—N═C═O) group and a hydroxyl (—OH) group forms a urethane (carbamate) (—O—CO—NH—) link. Polyurethane is a polymer composed of at least one urethane (carbamate) link. It is highly desirable to utilize urethane segments because urethane bond is chemically stable and can be formed under ambient temperature.

In the present invention, a polyurethane having interpenetrating polymer network material as hydrophobic polymer comprises of: (a) at least a polyfunctional reactant having a plurality of hydroxyl functional groups; (b) at least a polyfunctional isocyanate selected from the group consisting of monomeric diisocyanate, oligomeric polyisocyanate, polyfunctional isocyanate prepolymer, modified polyisocyanate and a mixture thereof; (c) at least a catalyst, said catalyst is selected from the group consisting of tertiary amine, organometallic complex, and a mixture thereof. Interpenetrating polymer network containing fluorinated polyol, especially, the copolymer of fluorinated olefin and hydrocarbon vinyl ether polyol, imparts UV, weathering, and chemical resistance, low surface energy, hydrophobic by fluorinated polymer into IPN polyurethane coatings.

A preferred fluorinated polyol in present invention is the fluorinated reactant with telechelic hydroxyl functional groups to the chain ends, or the fluorinated reactant with pendant functional hydroxyl functional groups.

A preferred polyfunctional isocyanate in present invention is selected from the group consisting of monomeric diisocyanate, oligomeric polyisocyanate, polyfunctional isocyanate prepolymer, modified polyisocyanate and a mixture thereof. A composition of fluorinated polyol, aliphatic polyol, and polyisocyanate forms a hydrophobic IPN fluorinated polyurethane coating.

A method of making composite preventing ice adhesion and with fluorinated polyurethane coating having IPN comprising steps of: (a) providing a substrate, (b) applying an interpenetrating polymer network fluorinated polyurethane material to the top of said substrate to form coated surface, (c) roughening said coated surface to form a plurality of micro-roughened surfaces by roughening means, (d) conducting surface reaction between micro-roughened surfaces of polymer and reactive organometallics results in organometallized micro-roughened layers, and (e) wetting organometallized micro-roughed layers with a hydrophobic, low freezing point liquid.

### Hydrophobic, Low Freezing-Point Liquids

In the present invention, a hydrophobic liquid with a low freezing point is applied to wetting micro-roughened, or organometallized micro-roughed surfaces for the novel composite for preventing ice adhesion.

The liquid with lowest pour points are known: poly(pentamethylcyclopentasiloxane) (122 K), poly(diethylsiloxane) (134 K), poly(oxytetrafluoroethylene-co-oxydifluoromethylene) (140 K), low molecular weight polychlorotrifluoroethylene (144 K), polydimethylsiloxane (146 K), polythiodifluoromethylene (155 K), and polytrifluoropropylsiloxane (203 K).

Many hydrophobic liquids with a low freezing point, low surface energy, high flash point, chemical, hydrolysis, UV, weathering resistant, and environmental friendly are commercially available, such as: poly(pentamethylcyclopentasiloxane), polydiethylsiloxane, poly(oxytetrafluoroethylene-co-oxydifluoromethylene), polydimethylsiloxane, poly(dimethylsiloxane-co-diethylsiloxane), poly(ethylmethylsiloxane), polythiodifluoromethylene, poly(methyltrifluoropropylsiloxane), poly(methyltrifluoropropylsiloxane-co-dimethylsiloxane), perfluoropolyether, polyisobutene, polyhexafluoropropylene oxide, perfluoropolyalkyl ether, perfluoroalkyl ether substituted s-triazine, fluorinated ether, polychlorotrifluoroethylene, polyalphaolefin (PAO), polyalphaolefin hydrogenated, polybutene.

In the present invention, the preferred low freezing point liquid is selected from the group consisting of poly(pentamethylcyclopentasiloxane), polydiethylsiloxane, poly(oxytetrafluoroethylene-co-oxydifluoromethylene), polydimethylsiloxane, poly(dimethylsiloxane-co-diethylsiloxane), poly(ethylmethylsiloxane), poly(methyltrifluoropropylsiloxane), poly(methyltrifluoropropylsiloxane-co-dimethylsiloxane), perfluoropolyether, polyhexafluoropropylene oxide, perfluoropolyalkyl ether, perfluoroalkyl ether substituted s-triazine, fluorinated ether, polychlorotrifluoroethylene, polyalphaolefin hydrogenated, polyalphaolefin, and a mixture thereof.

In present invention, preferred silicone oil as low freezing point liquids are: polydimethylsiloxanes having a molecular weight between 2,000 to 14,000, a pour point from −65° C. to −60° C., viscosity from 20-350 cSt, and de-volatilized (>90% low molecular weight components removed); polydiethylsiloxanes having a molecular weight from 350-400, 400-500, 500-800, 1300-2000, viscosity from 19 to 300 cSt, and a pour point from −110° C. to −96° C.; and methyl-T-branched polydimethylsiloxanes having a molecular weight of 1650 and pour point of −85° C.

In present invention, polyalphaolefin and polyalphaolefin hydrogenated are selected as low freezing point liquid. Preferred polyalphaolefin or polyalphaolefin hydrogenated is selected from the group consisting of 1-decene dimer, 1-dodecene dimer, 1-decene dimer hydrogenated, 1-dodecene dimer hydrogenated, 1-decene homopolymer, 1-decene homopolymer hydrogenated, 1-dodecene homopolymer, 1-dodecene homopolymer hydrogenated, 1-decene trimer, 1-decene trimer hydrogenated, 1-dodecene trimer, 1-dodecene trimer hydrogenated, poly(1-dodecene-co-1-octene) hydrogenated, and a mixture thereof.

The preferred low molecular weight polychlorotrifluoroethylene (PCTFE) oil are: pour point −71° C. and viscosity 6.3 cSt @ 37.8° C., pour point −73° C. and viscosity 4.2 cSt @ 37.8° C., pour point −93° C. and viscosity 1.8 cSt @ 37.8° C., and pour point −129° C. and viscosity 0.8 cSt @ 37.8° C. Perfluoropolyethers (PFPE) are a class of low molecular weight fluoropolymers. The basic repeated units are CF₂O, CF₂CF₂O, CF₂CF₂CF₂O, and CF(CF₃)CF₂O, while the terminal groups of the polymer chain can be CF₃O, C₂F₅O, and C₃F₇O. Commercially important PFPE products are Krytox®, Demnum®, Fomblin®, and Galden®. The preferred PFPE has a pour point of (−62° C.), an average molecular weight of 1,500, low surface energy (21 dyne/cm), low viscosity (40 cSt), low volatility (10⁻³ mm Hg), and a density higher than water (1.87 g/cm³). PFPE has properties that are ideal for a hydrophobic, low freezing point liquid for the present invention. Surface enrichment of molecules with high fluorine contents is known art. Small amount of addition of high fluorine compounds, such as perfluoropolyether and fluorinated polysiloxane, is utilized for reduce surface energy of low freezing point liquid.

However, PFPE is very expensive. Therefore, it best used for applications for small critical areas or as an additive in low concentrations to low freezing point liquids to reduce surface energy for large area applications. The preferred concentration of PFPE in a low freezing point liquid is between 2.5%-0.05%.

Other options for a hydrophobic, low freezing point liquid include fluorinated polysiloxane, such as poly(methyltrifluoropropylsiloxane) with a molecular weight of 900-1,000, 2,400, pour point from −47° C. to −40° C., density from 1.24-1.25; and poly(methyltrifluoropropylsiloxane-co-dimethylsiloxane) with a molecular weight of 1,800, pour point of −55° C., and density of 1.16. However, since they are expensive, they are best used for small area application or as an additive for reducing the surface energy or adjusting the viscosity of a low freezing point liquid.

A preferred perfluorinated fluid Fluoinert™ is FC 77 having molecular weight 415 and pour point −95° C.

### Hydrophobic Polymers

Generally, if water contact angle is small than 90°, the material is considered hydrophilic. If the water contact angle is greater than 90°, the material is considered hydrophobic.

Preferred polymer is a polymer which exhibits hydrophobic surface. In present invention, hydrophobic polymer is selected from the group consisting of polyurethane, polyurea, fluorinated polyurethane, fluorinated polyurea, polysiloxane, interpenetrating polymer network material, high density polyethylene, low density polyethylene, polyethylene, chlorinated polyvinyl chloride, polyvinyl chloride, polypropylene, polyethylene terephthalate, polymethylmethacrylate, polycarbonate, acrylonitrile-butadiene-styrene, polyamide, polyimide, polysulfone, polyamide-imide, polyetherimide, polyether ether ketone, polyaryletherketone, cyclic olefin copolymer, ethylene-vinyl acetate, polyoxymethylene, polyacrylate, polyacrylonitrile, polybutadiene, polybutylene, polycaprolactone, polyester, polyvinylidene chloride. polyolefin, polyolefin blend, cycloolefin polymer, poly(ethylene-co-propylene), polybutylene-terephthalate, polyvinyl acetate, polyacrylethersulphone, liquid crystal polymer, polyurea elastomer, polyurethane elastomer, nature polyisoprene, cis-1,4-polyisoprene, trans-1,4-polyisoprene, synthetic polyisoprene, polybutadiene rubber, chloroprene rubber, Neoprene, poly(isobutylene-co-isoprene), chlorobutyl rubber, nitrile rubber, epoxide rubber, hydrogenated nitrile rubber, ethylene propylene rubber, ethylene propylene diene rubber, epichlorohydrin rubber, polyacrylic rubber, polypentenamer, polyalkenamer, polyoctenamer, polynorbornene, poly(dicyclopetadiene), polycyclorene rubber, butadiene-acrylonitrile rubber, silicone rubber, polyether block amide, chlorosulfonated polyethylene, polysulfide rubber, fluorosilicone rubber, fluoroelastomer, perfluoroelastomer, Tiokol, polypentenomer, alternating rubber, polyether ester, polyolefin blend, elastomeric alloy (TPE-v, TPV), thermoplastic polyurethane, thermoplastic copolyester, thermoplastic polyamide, radiation curing, electron beam curing, oligoethylene, oligopropylene, hydrocarbon resin, oligoether, oligoester, polyvinyl acetal, polyvinyl ketone, polylactic acid, polyisocyanate, and a mixture thereof.

Present invention, hydrophobic polymer is also selected from the group made of thermoplastic, elastomer, thermoplastic elastomer, thermoset elastomer, polyurethane, polyurea, solvent-borne coating, powder coating, fiber-reinforced polymer composite, powder coating, UV coating, casting, vacuum casting, centrifugal casting, molding, injection-molding, injection-molding sheet, reaction injection molding (RIM), structural reaction molding (SRIM), reinforced reaction molding (RRIM), polymer film coating, and a mixture thereof.

A preferred thermoplastic as hydrophobic material is selected from the group consisting of high density polyethylene (HDPE), low density polyethylene (LDPE), polyethylene (PE), polyvinyl chloride (PVC), polypropylene (PP), polyethylene terephthalate (PET), polymethylmethacrylate (PMMA), polycarbonate (PC), acrylonitrile-butadiene-styrene (ABS), polyamide (Nylon 6), polyimide (PI), polysulfone (PSF), polyamide-imide (PAI), polyetherimide (PEI), polyether ether ketone (PEEK), polyaryletherketone (PEAK). cyclic olefin copolymer (COC), ethylene-vinyl acetate (EVA), polyoxymethylene (POM), polyacrylate (Acrylic), polyacrylonitrile (PAN), polybutadiene (PBD), polybutylene (PB), polycaprolactone (PCL), polyester (PE), polyurethane (PU), polyurea, polyvinylidene chloride (PVDC). polyolefin, polyolefin blend, poly(ethylene-co-propylene), PP/EPDM, polystyrene (PS), polybutylene-terephthalate (PBT), polyphenylene ether (PPE), polyvinyl acetate (PVA), polyacrylethersulphone (PAES), polyphenylene sulfide, Liquid Crystal Polymer (LCP), and a mixture thereof.

A preferred elastomer as hydrophobic material is specified by a high value of elongation at break and a low Tg (Glass Transition Temperature).

Elastomers for spray coating and cast and reaction injection molding (RIM) are commercially available. A special spray elastomeric polyurea has a Tg between −50° C. to −60° C., and a special spray elastomeric polyurethane has a Tg between −40° C. to −50° C. Other elastomers with a Tg lower than −40° C. are also known, such as natural rubber, fluorinated silicone rubber, styrene butadiene rubber, butadiene acrylonitrile rubber, isoprene rubber, butadiene rubber, chloroprene rubber, butyl rubber, silicone rubber, urethane rubber, thiokol rubber, fluoroelastomer, acrylate rubber, ethylene-propylene rubber, epoxide rubber, polypentenomer, and alternating rubber.

In the present invention, a preferred elastomer as hydrophobic material is selected from the group consisting of polyurea elastomer, polyurethane elastomer, nature polyisoprene, cis-1,4-polyisoprene (natural rubber NR), trans-1,4-polyisoprene (gutta-percha), synthetic polyisoprene (IR), polybutadiene rubber (BR), chloroprene rubber (Neoprene, CR), poly(isobutylene-co-isoprene) (Butyl rubber, IIR), chlorobutyl rubber (CIIR), nitrile rubber (NBR), hydrogenated nitrile rubber (HNBR), ethylene propylene rubber (EPM), ethylene propylene diene rubber (EPDM), epichlorohydrin rubber (ECO), polyacrylic rubber (ACM, ABR), silicone rubber (VMQ), polyether block amide (PEBA), chlorosulfonated polyethylene (CSM), polysulfide rubber, fluorosilicone rubber (FVMQ), fluoroelastomer (FKM and FEPM), perfluoroelastomer (FFKM), polybutadiene-acrylonitrile, Tiokol, fluoroelastomer, polypentenomer, alternating rubber, polystyrene, polyether ester, polysulfide, and a mixture thereof.

A preferred thermoplastic elastomer as hydrophobic material is selected from the group consisting of polystyrenic block copolymer, polyolefin blend, elastomeric alloy (TPE-v, TPV), thermoplastic polyurethane, thermoplastic copolyester, thermoplastic polyamide, and a mixture thereof.

In the present invention, a fiber-reinforced polymer composite containing hydrophobic polymer is preferred as hydrophobic material, said fiber is selected from the group consisting of glass fiber, carbon fiber, Aramid fiber, wood fiber, and a mixture thereof, said polymer is selected from the group consisting of unsaturated polyester (UP, UPE), epoxy (EP), polyamide (PA, Nylon), vinyl ester, polyoxymethylene (POM), polypropylene (PP), polyethylene (PE), high density polyethylene (HDPE), polycarbonate (PC), acrylonitrile-butadiene-styrene (ABS), polyvinyl chloride (PVC), polyethylene terephthalate (PET), polybutylene-terephthalate (PBT), polylactic acid (PLA), vinyl ester (VE), and a mixture thereof.

In the present invention, a material made of injection molding containing hydrophobic polymer is preferred as hydrophobic material. The hydrophobic polymer used in injection molding is selected from the group consisting of thermoplastic, thermoset, elastomer, metal, and a mixture thereof. In the present invention, a preferred polymer made of casting, vacuum casting, and centrifugal casting with hydrophobic material. The polymer used in casting, vacuum casting, and centrifugal cast is selected from the group consisting of thermoplastic, thermoset, elastomer, metal, and a mixture thereof.

In the present invention, a preferred material made of reaction injection molding (RIM), structural reaction molding (SRIM), or reinforced reaction molding (RRIM), and containing hydrophobic polymer is preferred as hydrophobic material. The reinforcing materials used in RIM, SRIM, or RRIM is selected from the group consisting of glass fiber, carbon fiber, Aramid fiber, wood fiber, mica and a mixture thereof. Thermosetting polymer in said RIM, SRIM, and RRIM is selected from the group consisting of polyurethane, polyurea, polyisocyanate, unsaturated polyester, polyester, polyphenol, epoxy, polyamide, vinyl ester, and a mixture thereof,

Solvent-borne paints, UV curable paints, spray polyurethane, spray polyurea, powder coating, plasma or thermo-sprayed thermoplastic are all suitable as hydrophobic material.

In the present invention, a preferred solvent-borne coating as hydrophobic material is selected from the group consisting of oxidative drying resin, amino resin, unsaturated polyester, epoxide, radiation curing, electron beam curing, vinyl polymer, alkyd resin, oligoethylene, oligopropylene, hydrocarbon resin, oligoether, oligoester, polyurethane, polyurea, epoxy, polyacrylic, polyamide, polyimide, polycarbonate, polydiene, polyester, polyether, polyfluorocarbon, polyolefin, polystyrene, polyvinyl acetal, polyvinyl chloride, polyvinylidene chloride, polyvinyl ester, polyvinyl ether, polyvinyl ketone, and a mixture thereof.

### Reactive Organometallics

In present invention reactive organometallics are preferred for generating organometallized surfaces for composite preventing ice adhesion. The preferred reactive organometallics include the classes of silanes, mono functional polysiloxanes, di-functional polysiloxanes, multi-functional polysiloxanes, organotitanates, organozirconates, and organoaluminates.

The preferred reactive silanes, or called silane coupling agents, for the present invention are: as following: allyltrimethoxysilane, allyltriethoxysilane, 3-acryloxypropyl trimethoxysilane, 3-aminopropyl triethoxysilane, 3-aminopropyl trimethoxysilane, 4-aminobutyl triethoxysilane, 3-aminopropyl tris(methoxyethoxyethoxy)silane, 11-amino-undecyl triethoxysilane, 3-aminopropylmethyl dimethoxysilane, 3-aminopropyldiisopropyl ethoxysilane, N-(2-aminoethyl)-3-aminopropyl trimethoxysilane, 1,2-bis[(trimethoxysilyl)propyl]ethylenediamine, azidosulfonylhexyl triethoxysilane, bis(trimethoxysilyl) octane, bis(trimethoxysilylpropyl)amine, N-butylaminopropyl trimethoxysilane, 3-chloropropyl triethoxysilane, 3-chloropropyl trimethoxysilane, N-cyclohexylaminopropyl trimethoxysilane, N-ethylaminoisobutyl trimethoxysilane, 3-glycidopropyl trimethoxysilane, 2-(3,4-epoxycyclohexyl)ethyl trimethoxysilane, 2-(3,4-epoxycyclohexyl)ethyl trimethoxysilane, (3-glycydoxypropyl) triethoxysilane, (3-glycydoxypropyl) trimethoxysilane, hexenyltriethoxysilane, N-(hydroxyethyl)-N-methylaminopropyl trimethoxysilane, bis(2-hydroxyethyl)-3-aminopropyl triethoxysilane, 3-hydroxypropyl trimethoxysilane, 3-isocyanatopropyl triethoxysilane, 3-isocyanatopropyl trimethoxysilane, 3-methacryloxypropyl trimethoxysilane, N-methylaminopropyl trimethoxysilane, 3-mercaptopropyl trimethoxysilane, 3-thioisocyanatopropyl trimethoxysilane, bis(triethoxysilyl)ethane, bis-(trimethoxysilylpropyl)amine, bis[3-(triethoxysilyl)propyl]tetrasulfide, bis(trimethoxysilylpropyl)amine, 3-(triethoxysilyl)propyl succinic anhydride, ureidopropyl triethoxysilane, ureidopropyl trimethoxysilane, vinyltriacetoxysilane, vinyltriethoxysilane, and vinyltrimethoxysilane.

The preferred organotitanates in present invention are as following: titanium di-n-butoxide (bis-2,4-pentanedionate), titanium diisopropoxide (bis-2,4-pentanedionate), titanium diisopropoxide bis(ethylacetoacetate), titanium 2-ethylhexoxide, titanium di-n-butoxide, titanium (bis-2,4-pentanedionate), titanium diisopropoxide, titanium (bis-2,4-pentanedionate), titanium diisopropoxide, titanium bis(ethylacetoacetate), titanium 2-ethylhexoxide, and titanium trimethylsiloxide.

The preferred organozirconates in present invention are as following in present invention: zirconium dionate, zirconium tetrakis(2,4-pentanedionate) complex and dialkylzirconium dionate,

The preferred organoaluminates in present invention are as following organoaluminate in present invention: Aluminum dionate, aluminum tris(2,4-pentanedionate) complex.

The preferred polysiloxane with hydrolyzable functional groups are preferred. Following are preferred hydrolyzable reactive polysiloxane in present invention: Chlorine terminated polydimethylsiloxane having a molecular weight of 425-650, 2,000-4,000, or 15,000-20,000; Diacetoxymethyl terminated polydimethylsiloxane having molecular weight of 36,000; Triethoxysilyl terminated polydimethylsiloxane having a molecular weight of 900-1,000; Ethoxy terminated polydimethylsiloxane having a molecular weight of 800-900; and methoxy terminated polydimethylsiloxane having a molecular weight of 900-1,000.

The mono functional polysiloxane are preferred. Following are preferred mono functional polysiloxane in present invention: Monofunctional terminated polysiloxanes having various reactive functional groups and high molecular weights are commercial available. There are two classes of mono functional polysiloxanes: asymmetric and symmetric. In present invention, following mono functional polysiloxanes are preferred: Asymmetric mono aminopropyl terminated polydimethylsiloxane having a molecular weight of 300-500; Asymmetric mono carbinol hydroxyethoxy terminated polydimethylsiloxane having a molecular weight of 1,000, 5,000 or 10,000; Symmetric mono carbinol hydroxypoly(ethyleneoxy)propyl functional polydimethylsiloxane having a molecular weight of 550-650; Asymmetric mono dicarbinol terminated polydimethylsiloxane having a molecular weight of 1,000 or 5,000; Symmetric mono carboxy functional polydimethylsiloxane having a molecular weight of 1,500; Asymmetric, mono (2,3-epoxy) propylether terminated polydimethylsiloxane having a molecular weight of 1,000 or 5,000; Symmetric mono (2,3-epoxy)propylether functional polydimethylsiloxane having a molecular weight of 800-900; Asymmetric mono hydride terminated polydimethylsiloxane having a molecular weight of 800-900 or 4,500-5,000; Asymmetric mono methacryloxypropyl terminated polydimethylsiloxane having a molecular weight of 600-800, 800-1,000, 5,000 or 10,000; Symmetric mono methacryloxypropyl functional polydimethylsiloxane having a molecular weight of 800-1,000; Symmetric mono methacryloxypropyl functional poly(trifluoropropylmethyl)siloxane having a molecular weight of 800-1,000; Asymmetric mono vinyl terminated polydimethylsiloxane having a molecular weight of 5,500-6,500 or 55,000-65,000, and symmetric mono vinyl functional polydimethylsiloxane having a molecular weight of 1,200-1,400.

In present invention alpha-, omega-, terminated di-functional, and pendant functional polysiloxane are among the preferred reactive polysiloxanes: Vinyl terminated polydimethylsiloxane having a molecular weight of 500, 800, 6,000, 9,400 or 17,200. Vinyl terminated polydiethylsiloxane having a molecular weight of 8,000-12,000; Vinylmethylsiloxane-dimethylsiloxane copolymer having a molecular weight of 250-300, 700-800, or 800-1,200; Poly(vinylmethylsiloxane) homopolymer having a molecular weight of 250-400 or 1,000-1,500; Hydride terminated poly(methylhydrosiloxane) having a molecular weight of 400-500, 1,000-1,100, 6,000 or 17,200; Trimethylsiloxy terminated methylhydrosiloxane-dimethylsiloxane copolymer having a molecular weight from 900-1,200, 1,900-2,000, or 5,500-6,500; Trimethylsiloxy terminated polymethylhydrosiloxane having a molecular weight of 1,400-1,800, 1,800-2,100 or 2,100-2,400; Silanol terminated polydimethylsiloxane have a molecular weight of 400-700, 700-1500, 2,000-3,500 4,200, or 18,000; Silanol terminated polytrifluoropropylmethylsiloxane having a molecular weight of 550-800 or 800-1,200; Hydroxypropyl terminated polydimethylsiloxanes having a molecular weight of 1000, 2000, 3000, 4000, 5000, or 8000; Hydroxyethyoxypropyl terminated polydimethylsiloxane having a molecular weight of 2000, 4000, 5000 or 8000; Hydroxyhexyl terminated polydimethylsiloxane having a molecular weight of 2000, 4000, 5000, or 8000; Hydroxybutyl terminated polydimethylsiloxane having a molecular weight of 2000, 3000, 4000, 5000, or 8000; Hydroxyhexyl terminated polydimethylsiloxane having a molecular weight of 2000, 3000, 4000, 5000 or 8000. Aminopropyl terminated polydimethylsiloxanes having a molecular weight of 850-900, 900-1,000, 3,000, or 5,000; Aminohexyl terminated polydimethylsiloxane having a molecular weight of 2,000, 3,000, 4,000, 5,000, or 8,000; Alpha, omega-di[(N-ethyl)amino(2-methyl)propyl]polydimethylsiloxane having a molecular weight of 2,000, 3,000, 4,000, 5,000, 8,000 or 10,000; Alpha, omega-di[(N-methyl)amino(2-methyl)propyl]polydimethylsiloxane having molecular weight of 2,000, 3,000, 4,000, 5,000, 8,000 or 10,000. Epoxypropoxypropyl terminated polydimethylsiloxanes having a molecular weight of 360, 500-600, 1,000-1,400, or 4,500-5,500; (Epoxypropoxypropyl methylsiloxane)-dimethylsiloxane copolymer having a molecular weight of 7,000 or 9,000; (Epoxycyclohexylmethylsiloxane)-dimethylsiloxane copolymer having molecular weight of 10,000-12,000; Epoxycyclohexylethyl terminated polydimethylsiloxane having a molecular weight of 900-1,000; Hydroxypropyl terminated polydimethylsiloxanes having a molecular weight of 1000, 2000, 3000, 4000, 5000, or 8000; Methacryloxypropyl terminated polydimethylsiloxane having a molecular weight of 380-550, 900-1,200, 4,500-5,000 or 10,000; 3-Acryloxy-2-hydroxypropoxypropyl terminated polydimethylsiloxane having a molecular weight of 600-900; Acryloxypropylmethylsiloxane-dimethylsiloxane copolymer having a viscosity of 80-120 cSt; Succinic anhydride terminated polydimethylsiloxane having a molecular weight of 600-800; Carboxyalkyl terminated polydimethylsiloxane having a molecular weight of 1,000, or 10,000. Mercaptopropylmethylsiloxane-dimethylsiloxane copolymer having a molecular weight of 6,000-8,000, or 4,000-7,000; Chloromethyl terminated polydimethylsiloxane having a molecular weight of 6,000-8,000; Chloropropylmethylsiloxane=dimethylsiloxane copolymer having a molecular weight of 7,500-10,000.

### Reaction Medium

In the present invention, water, aqueous organic solvents and organic solvents with moisture water contents are preferred as reaction medium for generate organometallized surfaces. Inorganic acids and their salts, organic acids and their salts, and alkali are added to adjust pH value of reaction medium. The micro-roughened surfaces also need to be cleaned before organometallization. Water, aqueous solvents or organic solvents can be used to cleaning polymer surfaces. VOC-exempted organic solvents by EPA are preferred, such as acetone, methyl acetate, tert-butyl acetate, methylene chloride, methyl chloroform, and cyclic, branched, or linear completely methylated siloxanes. The preferred solvents also include acetonitrile, N,N-dimethylformamide, N,N-dimethylacetamide, 1-methyl-2-pyrrolidone, acetophenone, amyl acetate, benzyl benzoate, bis(2-ethylhexyl) adipate, bis(2-ethylhexyl) phthalate, butanol, iso-butanol, butanone, n-butyl acetate, sec-butyl acetate, n-butyl propionate, gama-butylolactone, chloroform, cyclohexanone, cyclopentanone, dichloromethane, diethyl carbonate, diethyl ketone, diisobutyl ketone, dimethyl carbonate, N,N-dimethylacetamide, N,N-dimethylformamide, dimethyl sulfoxide dioctyl terephthalate, 1,4-dioxane, ethanol, ethyl acetate, 2-ethoxyethyl ether, ethyl acetoacetate, ethyl butyrate, ethyl lactate, ethylene carbonate, cyclobutanone, ethyl isopropyl ketone, hexyl acetate, isoamyl acetate, isobutyl acetate, isobutyl isobutyrate, isopropyl acetate, isophorone, methanol, mesityl oxide, methyl acetate, methyl amyl acetate, methyl butyl ketone, methyl ethyl ketone, methyl isoamyl ketone, methyl isobutyl ketone, methyl isopropyl ketone, methyl phenylacetate, methyl propyl ketone, 1-methyl-2-pyrrolidinone, octyl acetate, 3-pentanone, n-pentyl propionate, propanol, iso-propanol, propyl acetate, beta-propyolactone, tetrahydrofuran, toluene, triacetin, delta-valerolactone, xylene, and cyclic, branched, or linear completely methylated siloxanes.

Substrate for Polymer coating.

In the present invention, if coating or paint is required to make a composite preventing ice adhesion, a substrate is required. A coating or paint can be applied on any solid surfaces served as substrate. Unlimited solid materials can be used as a substrate for polymer coatings. It includes metals, alloys, ceramic, glass, thermoplastic, thermoset, elastomer, thermoset elastomer, thermoplastic elastomer, fiber-reinforced polymer composite, injection molding, casting, vacuum casting, centrifugal casting, reaction injection molding (RIM), structural reaction molding (SRIM), and reinforced reaction molding (RRIM).

### EXAMPLES

Objects and advantages and embodiments of this invention are further illustrated by the following examples, but the particular materials and amounts thereof recited in these examples, as well as other conditions and details, should not be construed to unduly limit this invention. These examples are merely for illustrative purposes only and are not to limit the scope of the appended claims.

### Example 1

### Synthesis of Fluorinated Polyol

A 4 liter autoclave equipped with a stirrer, gas inlet port, liquid injection port, liquid sampling port, and a thermocouple, was pre-dried. 925 g of tert-butyl acetate, 552 g of Versatic 9 vinyl ester (3.0 mole, VeoVa 9), and 87 g of hydroxypropyl vinyl ether (0.75 mole) were charged in under −20° C. and slowly stirred. The autoclave was evacuated for 10 minutes and purged five times with nitrogen at 5 Bars. The autoclave was then charged with tetrafluoroethylene (TFE) under 10 Bars of pressure and heated to 95° C. Then, the autoclave was charged with tetrafluoroethylene (TFE) containing 0.01% propane under 12 Bars of pressure. 1.0 ml 0.01M of di-tert-amyl peroxide (DTAP) in t-butyl acetate solution containing 1.74 g/L of di-tert-amyl peroxide was injected to initiate polymerization. Every 10 minutes thereafter, 1.0 ml of the 0.01M di-t-amyl peroxide in t-butyl acetate solution was injected. Additionally, TFE containing 0.01% propane was continuously charged in order to maintain the pressure at 12 Bars during the polymerization and the consumption of TFE was recorded. After 5 hours, a total of 383 g (3.83 mole) of TFE was charged and both the initiator solution and TFE supply were stopped. The mixture temperature was allowed to slowly rise to 120° C. and kept there for 1 hour. Afterward, the mixture in the autoclave was lowered to room temperature and then purged with nitrogen to remove unused TFE monomers, and the system was brought to atmospheric pressure. A total of 1957 g of product was recovered. 1024 g of hydroxyl polyfunctional fluorocopolymer solved in 933 g of tert-butyl acetate was obtained. From the results of NMR and infrared absorption spectrum analysis, the hydroxyl polyfunctional fluorocopolymer has alternating sequences of repeating units of fluorinated monomer and non-fluorinated monomer. The mole ratio of TFE:vinyl ether versatate:hydroxybutyl vinyl ether was 50/40/10 (mole %). The solids percentage was 52.3%, the hydroxyl value is 40.4 mg KOH/g, equivalent weight 1389. The VOC is 0 g/L.

### Example 2

### Preparation of Isocyanato Fluorinated Prepolymer) (3)

A 2,500 ml five-neck round-bottom glass flask having a heating/cooling jacket and equipped with turbine stirrer, thermocouple, nitrogen inlet, liquid dripping funnel, and condenser connected with a nitrogen bubbler was pre-dried. 500 g of hydroxyl polyfunctional fluorinated copolymer in tert-butyl acetate solvent obtained by Example 1 (52.3% solid, hydroxyl value 40.4 mg KOH/g, equivalent weight 1389), and 150 ml toluene was added. Nitrogen was bubbled into the solution under slow stirring. The flask was heated to a boiling temperature. The refluxing solvent was passed through 40 cm high, 18 mm O.D. column filled with dried 5 A molecular sieve, and returned to the flask. The refluxing was held for 1 hour. Then, the toluene was distilled out. The system was cooled to 25° C. 44 g of isophorone diisocyanate (1-isocyanatomethyl-1,3,3-trimethyl-5-isocyanato-cyclohexane, Bayer, Desmodur® I, Assay≧99.5%, NCO≧37.7%, equivalent weight 111) was admitted to the stirred mixture drop-wise slowly over a one hour under a nitrogen blanket. The temperature of the reaction mixture was kept below 40° C. to 50° C. by adjusting the drip rate and the medium temperature in the cooling jacket. To avoid a gelatin, the addition of isocyanate should be processed without interruption. The stirred reaction mixture was kept under 70° C. to 80° C. for an additional hour. The free isocyanate content was measured. The system was reduced to room temperature, and 2 ml of hydroquinone 10% solution in butyl acetate was added. A total of 510 g of polyfunctional isocyanato fluorinated prepolymer in tert-butyl acetate solution was obtained. The isocyanato functional fluorinated prepolymer had a solid content of 59.6% and NCO content of 2.62%, equivalent weight 1612.

### Example 3

### Preparation of PTFE/Fluorinated Polyol Blend) (4)

A 4-neck 500 ml borosilicate sonochemical reaction vessel equipped with mechanical stirring in the center neck, thermocouple in a side neck, pressure balance in a side neck, a 5 inch long and ¾ inch diameter ultrasonic horn (probe) in a side neck with bushing and an O-ring seal. A 600 Watt high intensity ultrasonic processor power supplier supplied the 20 kHz electricity into the horn. 106 g of fluorinated polyol obtained by Example 1 (52.3% solid, hydroxyl value 40.4 mg KOH/g, equivalent weight 1390), 28 g PTFE powder (DuPont, Zonyl® MP 1000, average agglomerate size of 8-15 micron, ultimate reduction to 200 nanometer), and 150 ml of methyl ethyl ketone were mixed in said reaction vessel which was placed in an ice-salt (1:3 ratio) bath (−20° C.). The contents were cooled by stirring until the temperature reached 0° C. The mixture was illuminated with an ultrasound (50% pulse mode) for 15 minutes. The temperature of the mixture rose to 17° C. After stopping ultrasonic illumination the mixture was kept under room temperature. A total of 234 g of a translucent blend of PTFE powders in fluorinated polyol was obtained (33.7% solid, PTFE concentration 33.6%, hydroxyl value 26.1 mg KOH/g, equivalent weight 2153).

### Example 4

### Ice Adhesion Test—Ice on Plate Test

Ultra Low freezer (LFZ-60 L, −60° C., upright) was modified to set temperature at −40 to −50° C., All shelves on a freezer rack were adjusted on horizontal position. Each shelve has a plastic skid plate for holding sample plates. Samples of composite plates were placed on plastic plate with face up. 20 separated distilled water drops with each 1.00 ml volume were delivered with lab pipette on each composite plate. Each plastic skid plate with samples was carefully slid in, and door of freezer was closed. After freezer reaching −40 to −50° C. and keeping for 1 hour, composite plate with frozen ice drops was removed from freezer for test ice adhesion. The separated ice drops were picked up by a nozzle of a potable vacuum cleaner, if adhesion force is low. The separated ice drops also can be swept-off from composite surface by air pulse from an air gun connected with low pressure compressed air (15 psig). Remained ice drops on composite surfaces will be counted if any. The procedure was repeated 20 times for each composite plate. If a composite shown that 80% of ice drops were separated and easily picked up by vacuum or swept-off by air pulse during 20 times of repeat icing/ice removal cycles, it define that the composite is ice phobic.

### Example 5

### Composite Preventing Ice Adhesion) (9)

Typical catalytic reaction composition of fluorinated polyurethane containing PTFE powder was prepared as following: 3.253 g of blend of PTFE powder in fluorinated polyol obtained in Example 3 (33.7% solid, PTFE 33.6%, hydroxyl value 26.1 mg KOH/g, equivalent weight 2153), 0.106 g of aliphatic polyisocyanate (Bayer, Desmodur® N3600, and equivalent weight 183), and 0.012 g of bismuth carboxylate catalyst (King Industries, K KAT® 348, 75% solid) were weighted into a test tube. The mixture was stirred vigorously.

Eight pieces of 100 mm×160 mm steel plate coated with epoxy primer were sanded with 220 grit (Norton, Wet/Dry) sandpaper as subtracts. The substrates for the samples were labeled. Each epoxy primed steel plate was coated with fresh prepared PTFE/fluorinated polyurethane sample with Double Blade Micrometer Film Applicator. The applicator was set to coat wet film thickness of 127 micron (5 mils). Preparation of PTFE/fluorinated polyurethane was repeated for supply coating for each substrate sample.

The samples were cured and dried under ambient temperature for 3 days.

The surfaces of all substrates were hand sanded by grit designation 240 sandpapers (3M, Wet/Dry) in a water bath. The samples were rinsed with water during sanding operation until superhydrophobic phenomenon appeared. The sanding was shifted onto next area until whole substrate surface become superhydrophobic.

After air dry, each sample surfaces was rinsed with ethanol three times and dried in atmospheric for 4 hours. Samples of PTFE/fluorinated polyurethane polymer coating with micro-roughened surfaces coated on epoxy primed steel plates were formed. Polydimethylsiloxane fluid (Dow Corning, Xiameter® PMX-200 200 cSt) was applied onto the surfaces of all samples by wipe tissue (Kodak lens cleaning paper). Micro-roughened composite wetted with hydrophobic, low freezing-point liquid were formed. The samples of anti-icing composite were tested for ice adhesion tests according to the Ice on Plate Tests of EXAMPLE 4. The composites for preventing ice adhesion were passed the ice phobic standard.

### Example 6

### Composite for Preventing Ice Adhesion

1.514 g of fluorinated polyol sample obtained by EXAMPLE 1 (52.3% solid, hydroxyl value 40.4 mg KOH/g, equivalent weight 1389), 1.604 g of isocyanato functional fluorinated prepolymer (59.6% solid, NCO contents 2.62%, and equivalent weight of 1612) obtained in Example 3, and 2 drops of tin catalyst (Air Products, Dabco® T-12) and 0.031 g were weighted in a test tube. The content was stirred vigorously. The fluorinated polyurethane was prepared.

Eight block of 102 mm×150 mm×20 mm micro closed cell polyurethane foams by reaction injection molding (RIM) were lightly sanded with 220 grit sandpaper (Norton, Wet/Dry) as subtracts. Each RIM foam block was coated with fluorinated polyurethane by Wire Wound Rod having wire size #50. The coats had wet film thickness of 127 micron (5 mils).

The preparation of fluorinated polyurethane was repeated for each substrate.

The samples were cured and dried under ambient temperature for 3 days. The substrates were hand sanded by grit designation 240 sandpapers (3M, Wet/Dry). The samples were rinse with water to remove sanding dusts. All samples were air dried for 1 day. Fluorinated polyurethane coatings with micro-roughened surfaces on IRM foam substrates were formed.

For grafting organometallized layers on micro-roughened polymer surfaces, silanes, polysiloxane, or their mixture that provide reactive functional groups are prepared as reactant. Reactive silane-polysiloxane in ethanol/water solution was prepared for this example as following: 2.507 g of asymmetric, mono (2,3-epoxy) propylether terminated polydimethylsiloxane (Gelest, MCR-E11, molecular weight 1,000), 0.521 g of 2-(3,4-epoxycyclohexyl)ethyl triethoxysilane, 50 ml of distilled water were mixed in 200 ml of ethanol in a 500 ml beaker. Acetic acid and sodium chloride were added to adjust acidity to pH 5.

All samples were wetted with micro-sprayer with acidified silane-polysiloxane aqueous ethanol solution. All samples were air dried in ambient temperature for 8 hours. Organometallized layers grafted on micro-roughened fluorinated polyurethane surfaces were prepared. Polydiethylsiloxane fluid (Gelest, DES-T23, 200-400 CST) was applied onto the surfaces of all samples by wipe tissue (Kodak lens cleaning paper). The samples of composite preventing ice adhesion witted with hydrophobic, low freezing-point liquid on organometallized layers grafted on micro-roughened surfaces were prepared. The samples of composite for preventing ice adhesion were tested by Ice on Plate Tests according EXAMPLE 4. All samples were ice-phobic defined by the tests.

### Example 7

### Isocyanato Fluorinated/Aliphatic Prepolymer

A 1,000 ml five-neck round-bottom glass flask having a heating/cooling jacket and equipped with stirrer, thermocouple, nitrogen inlet, liquid dripping funnel, and condenser connected with a vacuum pump system was pre-dried. 159.3 g of hydroxyl polyfunctional fluorinated copolymer in tert-butyl acetate solvent obtained by Example 1 (52.3% solid, hydroxyl value 40.4 mg KOH/g, equivalent weight 1389), 200.0 g of polycaprolactone polyol (Bayer, Baycol® AD5055, diol, hydroxyl value 56.0 mg KOH/g, equivalent weight 1,000), 80.0 g of polycarbonate polyol (Bayer, Desmophen® C2200, diol, hydroxyl value 56.0 mg KOH/g, equivalent weight 1,000), 40.0 g of polyether polyol (Bayer, Desmophen® 2060 BD, diol, hydroxyl value 28.5 mg KOH/g, equivalent weight 1,000), 60.0 g of polyether polyol (Bayer, Desmophen® 3061 BD, triol, hydroxyl value 56.0 mg KOH/g, equivalent weight 1,000), and 4.51 g of trimethylolpropane (hydroxyl value 1247 mg KOH/g, molecular weight 135.1, purity 99.8%), and 40.0 g of tert-butyl acetate were added. Glass flask was heated with nitrogen gas bubbled under slow stirring. The flask was heated to keep at boiling temperature. The refluxing solvent was pass through 40 cm high, 18 mm O.D. column filled with dried 5 A molecular sieve, and returned to the flask. The refluxing was held for 1 hour. Then the system was cooled to 30° C. 123.5 g of isophorone diisocyanate (1-isocyanatomethyl-1,3,3-trimethyl-5-isocyanato-cyclohexane, (Bayer, Desmodur® I, Assay ≧99.5%, NCO ≧37.7%, equivalent weight 111) was admitted to the stirred mixture drop-wise slowly over a one hour under a nitrogen blanket. The temperature of the reaction mixture was kept below 40° C. to 50° C. by adjusting the drip rate and the medium temperature in the cooling jacket. To avoid a gelatin, the addition of isocyanate should be processed without interruption. The stirred reaction mixture was kept under 70° C. to 80° C. for an additional 2 hours. The free isocyanate content was measured. The system was reduced to room temperature. 1 ml of 10% hydroquinone in butyl acetate was added. A total of 672 g of polyfunctional isocyanato fluorinated/aliphatic prepolymer was obtained. The isocyanato functional fluorinated/aliphatic prepolymer had solid content of 75%, NCO content of 3.93%, and equivalent weight 1067.

### Example 8

### Hydroxyl Functional Aliphatic Prepolymer

A 1,000 ml five-neck round-bottom glass flask having a heating/cooling jacket and equipped with stirrer, thermocouple, nitrogen inlet, liquid dripping funnel, and condenser connected with a vacuum pump system was pre-dried. 100.0 g of polycaprolactone polyol (Bayer, Baycol® AD5055, diol, hydroxyl value 56.0 mg KOH/g, equivalent weight 1,000), 80.0 g of polycarbonate polyol (Bayer, Desmophen® C2200, diol, hydroxyl value 56.0 mg KOH/g, equivalent weight 1,000), 20.0 g of polyether polyol (Bayer, Desmophen® 2060 BD, diol, hydroxyl value 28.5 mg KOH/g, equivalent weight 1,000), 120.0 g of polyether polyol (Bayer, Desmophen® 3061 BD, triol, hydroxyl value 56.0 mg KOH/g, equivalent weight 1,000), and 16.1 g of trimethylolpropane (hydroxyl value 1247 mg KOH/g, molecular weight 135.1, purity 99.8%), and 80.0 g of tert-butyl acetate were added. Glass flask was slowly heated with nitrogen gas bubbled under slow stirring. The flask was heated to keep at boiling temperature. The refluxing solvent was past through 40 cm high, 18 mm O.D. column filled with dried 5 A molecular sieve, and returned to the flask. The refluxing was held for 1 hour. Then the system was cooled to 35° C. 60.0 g of isophorone diisocyanate (1-isocyanatomethyl-1,3,3-trimethyl-5-isocyanato-cyclohexane, (Bayer, Desmodur® I, Assay ≧99.5%, NCO ≧37.7%, equivalent weight 111) was admitted to the stirred mixture drop-wise slowly over a one hour under a nitrogen blanket. The temperature of the reaction mixture was kept below 40° C. to 50° C. by adjusting the drip rate and the medium temperature in the cooling jacket. To avoid a gelatin, the addition of isocyanate should be processed without interruption. The stirred reaction mixture was kept under 70° C. to 75° C. for an additional 2 hours. Add 2.0 g of tin complex catalyst (Air Products, Dabco 112) and the stirred reaction mixture was kept under 70° C. to 75° C. for an additional 2 hours. The free isocyanato group was measured. The system was reduced to room temperature. 1 ml of 10% hydroquinone in butyl acetate was added. Product solid percentage was adjusted to 75% by addition of tert-butyl acetate. A total of 396 g of polyfunctional isocyanato fluorinated/aliphatic prepolymer was obtained. The hydroxyl functional prepolymer had solid 75%, hydroxyl value of 19.28, and equivalent weight 2911.

### Example 9

### Composite for Preventing Ice Adhesion

58.2 g of isocyanato fluorinated/aliphatic prepolymer obtained by Example 7 (solid content of 75%, NCO content of 3.93%, and equivalent weight 1067), and 20.1 g of hydroxyl functional aliphatic prepolymer by EXAMPLE 8 (solid content 75%, hydroxyl value of 19.28, and equivalent weight 2911) were mixed in a 500 ml beaker. 140 ml of tert-butyl acetate, 5 ml of acetone has added into the beaker. The mixture was stirred for 3 minutes by glass rod as composition of INP containing fluorinated polyurethane segments.

Dried, filtrated air was supplied to a gravity feed sprayer. The air pressure was set to 35 psig. Composition of INP containing fluorinated polyurethane segments was added into a cup of sprayer gun.

Selected substrates were following: Six pieces of ethanol pre-cleaned glass fiber-reinforced unsaturated polyester (polyester, Corvex®) composite of size 100 mm×160 mm were dried. Six pieces of ethanol pre-cleaned EPDM thermoplastic of size 110 mm×150 mm were dried. Six dried, anodized aluminum plates of size 100 mm×250 mm which were by pretreating with gamma-aminopropyl trimethoxy silane.

5 thin sprayed coating layers were applied to each substrate. The coated substrates were kept in ambient temperature on a shelf for 3 days. Polyurethane with Interpenetrating Polymer Networks containing fluorinated segments was prepared.

The coated samples were hand sanded by grit designation 240 sandpapers (3M Wet/Dry). The samples were wet sanded until whole surface became hydrophilic. All samples were dried by atmospheric air for 4 hours. Sample surfaces were wiped with methyl ethyl ketone five times and dried in atmospheric for 2 hours. Samples of micro-roughened polyurethane with Interpenetrating Polymer Networks (IPN) containing fluorinated segments were prepared.

Reactive silane-polysiloxane in ethanol/water solution was prepared for organometallization of micro-roughened polymer surfaces as following: 5.114 g of asymmetric, mono (2,3-epoxy) propylether terminated polydimethylsiloxane (Gelest, MCR-E11, molecular weight 1,000), 1.047 g of 2-(3,4-epoxycyclohexyl)ethyl triethoxysilane, 50 ml of distilled water were mixed in 400 ml of ethanol in a 1,000 ml beaker. Acetic acid was added to adjust acidity to pH 5.

All samples were wetted with a gravity feed sprayer gun and cup filled with reactive silane-polysiloxane aqueous ethanol solution. All samples were air dried in ambient temperature for 8 hours. Organometallized layers grafted on micro-roughened IPN polyurethane surfaces were prepared.

Polydiethylsiloxane fluid (Gelest, DES-T23, 200-400 CST) was applied onto the surfaces of all samples by wipe tissue (Kodak lens cleaning paper). The samples of composite preventing ice adhesion witted with hydrophobic, low freezing-point liquid on organometallized layers grafted on micro-roughened surfaces were prepared. The samples of composite preventing ice adhesion were tested following EXAMPLE 4 (Ice on Plate Tests). All samples were ice-phobic defined by the tests.

### Example 10

### Composite for Preventing Ice Adhesion

Five pilot tube speed sensors were used as polymer sample having complicated shape of surfaces. The material made of the sensor surfaces was unknown. The sensors were partially hand sanded with grit 240 sandpaper, and following with oxygen plasma etching in vacuum chamber of a PE-100 bench top plasma etching system. The etching was performed under oxygen ions exposed for 60 min by 300 W radio frequencies at 13.56 MHz. After oxygen plasma etching surfaces of sensors were shown hydrophilic.

Sensor surfaces were wiped with methyl ethyl ketone five times and dried in atmospheric for 2 hours

Reactive silane-polysiloxane in ethanol/water solution was prepared for organometallization of micro-roughened polymer surfaces as following: 0,508 g of silanol terminated polytrifluoropropylmethylsiloxane (Gelest, FMS 9922, molecular weight 800-1,200, hydroxy 3-5%), and 0.105 g of 3-glycidoxypropyl triethoxysilane were weighed in a testing tube. 3 drops of glacial acetic acid were added in the testing tube. The content in testing tube was vigorously stirred. The content was kept in room temperature for 4 hours, and poured in to a 500 ml beaker having 2 ml of distilled water and 250 ml of ethanol under stirring with glass rod. Each sensor was dipped in reactive silane-polysiloxane ethanol solution under 70° C. for 20 minutes. The sensors were rinsed with ethanol 3 times, and dried in an oven at 80° C. for 25 minutes. The sensors with organometallized micro-roughened surfaces were obtained.

Perfluoropolyether (Nye Lubricant, Inc., UniFlor® 8511, 65 cSt) was applied onto the surfaces of all samples by wipe tissue (Kodak lens cleaning paper). Perfluoropolyether oil wetted organometallized micro-roughened sensor surfaces were obtained. The sensor samples with the composite for preventing ice adhesion were tested for ice adhesion with Ice on Plate tests according EXAMPLE 4, and shown ice-phobic.

### Example 11

### Composite for Preventing Ice Adhesion

Following polymer sheet materials were obtained by Grainger®: ABS (aceylonitrile butadiene styrene), acetal copolymer, acetal homopolymer (Delrin®), acrylic (cast, food contact grade), acrylic (extruded), CPVC (chlorinated polyvinyl chloride), Nylon 6 (cast, food contact grade), Nylon 6/6 (extruded, food contact grade), PEEK, PET-P (Ertalyte®), PETG (copolyester, food contact grade), phenolic CE, phenolic LE, polyamide-imide extruded (Torlon®), polycarbonate (Lexan®), polycarbonate (machine grade), polycarbonate (bullet-resistant, Lexguard®), polycarbonate film (Lexan®), polyester film, polyetherimide (Ultem), polyethylene (HDPE), polyethylene (LDPE), polyethylene (Ultra Molecular Weight, UHMW, Tival), polypropylene, polyphenylene sulfide extruded (Techtron PPS), PVC type I (polyvinyl chloride). 10 sample sheets by each polymer varieties were prepared by cut to 100 mm×160 mm dimensions.

First sets of sample preparing followed the process of: (a) preparing micro-roughened polymer surfaces by sanding with grit 240 sandpaper, (b) wetting micro-roughened surfaces with hydrophobic, low freezing point liquids: poly(diethylsiloxane) fluid (Gelest, DES-T23, 200-400 CST) to form composites.

Ice on Plate Tests shown that the composites made of following hydrophobic polymers had icephobic properties: CPVC, UHMW polyethylene, HDPE polyethylene, LDPE polyethylene, polypropylene, and PVC.

Second sets of sample preparing followed the process of: (a) preparing micro-roughened polymer surfaces by sanding with grit 240 sandpaper, (b) conducting surface reaction by react reactive silane-polysiloxane solution with micro-roughened polymer surfaces to obtaining organometallized micro-roughened surfaces, and (c) wetting organometallized micro-roughened surfaces with hydrophobic, low freezing point liquid: Polydimethylsiloxane fluid (Dow Corning, Xiameter® PMX-200 200 cSt) was applied onto the surfaces of all samples by wipe tissue (Kodak lens cleaning paper) to form composite.

For grafting organometallized layers on micro-roughened polymer surfaces, silanes, polysiloxane, or their mixture that provide reactive functional groups are prepared as reactant.

Amino functional silane-polysiloxane solution was prepared: 3-aminopropyl trimethoxysilane (0.25%), asymmetric aminopropyl terminated polydimethylsiloxane (molecular weight of 900-1000, 0.5%), methanol (89%), and water (2%). Solution pH 8 to 9 was adjusted by addition KH₂PO₄ (0.001 M) and borax (0.001 M).

Amino functional silane/polysiloxane solution was for metallization of micro-roughened surface for materials of polyimide, polycarbonate, polyester, polyurethane, polyethylene, polyphenylene sulfide, polyetherketone, polybutylene terephthalate, polyamide (nylon), polysulfone, polysulfide, polyvinyl butyral, polyvinyl chloride, polyamide-imide, and chlorinated polyvinyl chloride. The surface reactions of amino functional silane/polysiloxane with micro-roughened polymer were conducted under ambient temperature for 45 minutes.

Polyethylene (UHMW, HDPE, and LDPE), polypropylene, and acrylate polymers were treated by two sequential surface reactions: The first step was a reaction with acrylic functional silane in the presence of radical initiator: methacryloxypropyl triethoxysilane (0.25%), and bis(tert-butyl) peroxide (2%) in methyl amyl ketone solution at 60-70° C. under nitrogen blanket for 20 minutes. The second step was a reaction with hydrolyzable asymmetric trimethoxysilyl polydimethylsiloxane (0.5%, molecular weight 1000-1200) in ethanol (98%)-water (2%) solution. Hydrolyzable polysiloxane ethanol solution had pH5 which was obtained by addition of acetic acid. The treatment was conducted under ambient temperature for 45 minutes.

Polydimethylsiloxane fluid (Dow Corning, Xiameter® PMX-200 200 cSt) was applied onto the surfaces of all samples by wipe tissue (Kodak lens cleaning paper). Ice on Plate Tests shown all composites with organometallized micro-roughened surfaces had icephobic properties.

### Example 12

### Ice Adhesion Test—Pull from Ice Test

Ultra Low freezer (LFZ-60 L, −60° C., upright) was modified to set temperature at −40 to −50° C., All shelves on a freezer rack were held on horizontal positions. Each shelve has a plastic skid plate for holding cups with samples. Each rod or tube sample of testing composite was placed and clamped at the center with vertical position in a plastic cup having diameter 70 mm and height of 50 mm. Distilled water was filled in each cup until reaching 45 mm height. Plastic skid plate with water filled plastic cups with testing rods or tubes was carefully sided in position, and freezer was closed. After freezer reaching −40 to −50° C. and keeping for 2 hour, sample rods or tube in frozen ice cup was removed from freezer for test ice adhesion. The frozen rod or tube was pulled out from ice by tension gauge with peak mode. The maximum force to remove rod or tube from frozen ice cup was recorded for each test. The maximum force was divided by rod or tube contacting area. The procedure was repeated 20 times for each composite sample. If a composite shown average maximum force required to pull out from frozen ice was less than 10 psi during 20 times of repeated removal tests, it define that the composite is ice phobic.

### Example 13

### Composite for Preventing Ice Adhesion

Following polymer round rod or tube (diameter of 8-12 mm) materials were obtained by Grainger®: ABS (acrylonitrile butadiene styrene), acetal copolymer, acetal homopolymer (Delrin®), acrylic (cast, food contact grade), acrylic (extruded), CPVC (chlorinated polyvinyl chloride) Nylon 6 (cast, food contact grade), Nylon 6/6 (extruded, food contact grade), PEEK, PET-P (Ertalyte®), PETG (copolyester, food contact grade), phenolic CE, phenolic LE, polyamide-imide extruded (Torlon®), polycarbonate (Lexan®), polycarbonate (machine grade), polycarbonate (bullet-resistant, Lexguard®), polycarbonate film (Lexan®), polyester film, polyetherimide (Ultem), polyethylene (HDPE), polyethylene (LDPE), polyethylene (Ultra Molecular Weight, UHMW, Tival), polypropylene, polyphenylene sulfide extruded (Techtron PPS), PVC type I (polyvinyl chloride). 10 sample rods by each polymer varieties were prepared by cut to 100 mm length.

Organometallized micro-roughened surfaces of rod or tube samples were prepared as follow: (a) preparing micro-roughened rod or tube surfaces by medium blasted with aluminum oxide abrasive (US sieve designation 220): sample rod or tube was spun held by 3-jaw chuck of a lathe machine, and blasted by abrasive supplied from a ceramic nozzle of a potable siphon feed blaster, (b) conducting surface reaction by react reactive silane, or silane-polysiloxane solution with micro-roughened polymer surfaces to obtaining organometallized micro-roughened surfaces, and (c) wetting organometallized micro-roughened surfaces with hydrophobic, low freezing point liquid. Amino functional silane-polysiloxane solution was prepared as following: 3-aminopropyl trimethoxysilane (0.25%), asymmetric aminopropyl terminated polydimethylsiloxane (molecular weight of 900-1000, 0.5%), methanol (89%), and water (2%). Solution pH 8 to 9 was adjusted by addition KH₂PO₄ (0.001 M) and borax (0.001 M).

Amino functional silane/polysiloxane was used for metallization of micro-roughened surface for materials of polyimide, polycarbonate, polyester, polyurethane, polyethylene, polyphenylene sulfide, polyetherketone, polybutylene terephthalate, polyamide (nylon), polysulfone, polysulfide, polyvinyl butyral, polyvinyl chloride, polyamide-imide, and chlorinated polyvinyl chloride. The surface reactions of amino functional silane/polysiloxane with micro-roughened polymer were conducted under ambient temperature for 1 hour.

Polyethylene (UHMW, HDPE, and LDPE), polypropylene, and acrylate polymers were treated by two sequential surface reactions: The first step was a reaction with acrylic functional silane in the presence of radical initiator: methacryloxypropyl triethoxysilane (0.25%), and bis(tert-butyl) peroxide (2%) in methyl amyl ketone solution at 60-70° C. under nitrogen blanket for 20 minutes. The second step was a reaction with hydrolyzable asymmetric trimethoxysilyl polydimethylsiloxane (0.5%, molecular weight 1000-1200) in ethanol (98%)-water (2%) solution. Hydrolyzable polysiloxane ethanol solution had pH5 which was adjusted by addition of acetic acid. The treatment was conducted under ambient temperature for 45 minutes.

Polydimethylsiloxane fluid (Dow Corning, Xiameter® PMX-200 200 cSt) was applied onto the surfaces of all samples by wipe tissue (Kodak lens cleaning paper). Pull from Ice Tests shown all composites with organometallized micro-roughened surfaces had icephobic properties.

### Example 14

### Composite for Preventing Ice Adhesion

5.162 g of 2-(3,4-epoxycyclohexyl)ethyl triethoxysilane was weight in a test tube, 4 drops of glacial acetic acid were added. The mixture was vigorously stirred and kept under room temperature for 1 hour. The content of test tube was poured into 250 ml of distilled water under stirring. A hydrolyzed silane solution was formed.

10 sheets of grit designation 240 sandpapers (3M Wet/Dry) were prepared as surface micro-roughened mold for press casting. Adhesive on the bake of sandpapers was removed. Sandpapers were wetted with hydrolyzed silane solution under room temperature. The wetted sandpapers were heated to 60°-70° C. for one hour in oven. Dried sandpapers were wetted with dimethylsiloxane fluid (Xiameter® PMX-200, viscosity 20,000 cSt) to form casting mold.

Thermoplastic elastomeric pellet materials of polyurethane, EPDM, neoprene, vinyl rubber, and Buna-N rubber obtained from various sources. Elastomer pallets of each variety were grinded to powder after liquid nitrogen freezing. Each 4-5 mm layer of elastomer powders was held on a sandpaper mold, and heated until melted in a heated press under nitrogen blanket. Elastomer powders melt form casted film with micro-roughened surfaces. The temperature of heated press was set 20-30° C. above the melting temperature of the material. After cooling to room temperature, elastomer samples were separated from the mold. Thermoplastic samples with micro-roughened surfaces were obtained.

All samples were cleaned with octamethylcyclotetrasiloxane, xylene, and cyclohexane to remove polydimethylsiloxane from surfaces.

A reactive silane mixture for elastomers and rubbers was prepared: 3-mercaptopropyl trimethoxysilane (0.25%), bis-[3-(triethoxysilyl)propyl]tetrasulfide (0.30%) in methyl ethyl ketone (98%) and water (2%) solution with pH 8.

The micro-roughened surfaces of thermoplastic elastomer samples were treated with reactive silane mixture for 1 hour under room temperature. Treated samples were dried under room temperature for 8 hours.

Organometallized—roughened surfaces of samples were wetted with hydrophobic, low freezing point liquid. Polydimethylsiloxane fluid (Dow Corning, Xiameter® PMX-200 200 cSt) was applied onto the surfaces of all samples by wipe tissue (Kodak lens cleaning paper) to form composite. All composite elastomer samples passed Ice on Plate tests of EXAMPLE 4.

1. A composite preventing ice adhesion comprises of:
(1a) a material having a plurality of micro-roughened surfaces,
(1b) a plurality of organometallized layers grafted on said surfaces and
(1c) a low freezing-pint liquid wetting said layers.

2. The composite of claim 1, wherein said low freezing-point liquid is a hydrophobic fluid selected from the group consisting of poly(pentamethylcyclopentasiloxane), polydiethylsiloxane, poly(oxytetrafluoroethylene-co-oxydifluoromethylene), polydimethylsiloxane, T-branched polydimethylsiloxane, poly(dimethylsiloxane-co-diethylsiloxane), poly(ethylmethylsiloxane), poly(methyltrifluoropropylsiloxane), poly(methyltrifluoropropylsiloxane-co-dimethylsiloxane), perfluoropolyether, polyhexafluoropropylene oxide, perfluoropolyalkyl ether, perfluoroalkyl ether substituted s-triazine, fluorinated ether, polychlorotrifluoroethylene, polyalphaolefin hydrogenated, polyalphaolefin, perfluoroalkyl silsesquioxane, and a mixture thereof.

3. The composite of claim 1, where said material is selected from the group consisting of polymer, interpenetrating polymer network, coating containing polymer, coating containing interpenetrating polymer network, fiber reinforced polymer, laminated polymer, composite polymer, polymer by injection molding, polymer by reaction injection molding, polymer by casting, and a mixture thereof.

4. The material of claim 3, where said polymer is selected from the group consisting of polyurethane, polyurea, fluorinated polyurethane, fluorinated polyurea, polyvinyl chloride, chlorinated polyvinyl chloride, polyethylene terephthalate, polymethylmethacrylate, polycarbonate, acrylonitrile-butadiene-styrene, polyamide, polyimide, polysulfone, polyamide-imide, polyetherimide, polyether ether ketone, polyaryletherketone, ethylene-vinyl acetate, polyoxymethylene, polyacrylate, cycloaliphatic epoxy, aliphatic epoxy acrylic, hybrid aliphatic epoxy, polyacrylonitrile, polybutadiene, polybutylene, polycaprolactone, polyester, polyvinylidene chloride. polybutylene-terephthalate, polyvinyl acetate, polyacrylethersulphone, liquid crystal polymer, oligoether, oligoester, polyurea elastomer, polyurethane elastomer, nature polyisoprene, cis-1,4-polyisoprene, trans-1,4-polyisoprene, synthetic polyisoprene, polybutadiene rubber, chloroprene rubber, neoprene, poly(isobutylene-co-isoprene), chlorobutyl rubber, nitrile rubber, epoxide rubber, hydrogenated nitrile rubber, ethylene propylene diene rubber, epichlorohydrin rubber, polyacrylic rubber, polypentenamer, polyalkenamer, polyoctenamer, polynorbornene, poly(dicyclopetadiene), polycyclorene rubber, butadiene-acrylonitrile rubber, silicone rubber, polyether block amide, chlorosulfonated polyethylene, polysulfide rubber, fluorosilicone rubber, fluoroelastomer, perfluoroelastomer, Tiokol, polypentenomer, alternating rubber, polyether ester, elastomeric alloy (TPE-v, TPV), thermoplastic polyurethane, thermoplastic copolyester, thermoplastic polyamide, radiation curing, electron beam curing, polyvinyl acetal, polyvinyl ketone, alkyd, polylactic acid, polyisocyanate, and a mixture thereof.

5. The composite of claim 1, wherein said plurality of micro-roughened surfaces is resulted from a roughing means being applied on said material according claim 3, leading to a surface with a preferred surface average roughness (RMS), and said roughing means is selected from the group consisting of laser etching, plasma etching, oxygen plasma etching, blasting with a medium, sanding with a sandpaper, extrusion with a surface roughened mold, molding with a surface roughened mold, casting on a surface roughened mold, and a mixture thereof.

6. A method of making a plurality of microroughened surfaces according claim 5, wherein said preferred surface average roughness (RMS) is between 5 to 25 microns, and more preferred in about 12.3-14.5 microns.

7. A method of making a plurality of microroughened surfaces according claim 5, wherein said medium, said sandpaper, or said surface roughened mold by grit designation is between grit 80 (177-210 microns) to grit 320 (32.5-36 microns), and more preferred in about grit 240 (50.0-53.5 microns).

8. The composite of claim 1, wherein said plurality of organometallized layers is resulted in a surface reaction between a reactive organometallics and said material on said plurality of micro-roughened surfaces, and said reactive organometallics is selected from the group consisting of reactive silane, reactive polysiloxane, organotitanate, organozirconate, organoaluminate, and a mixture thereof.

9. The plurality of organometallized layers of claim 8, wherein said reactive silane is selected from the group consisting of allyltrimethoxysilane, allyltriethoxysilane, 3-acryloxypropyl trimethoxysilane, 3-aminopropyl triethoxysilane, 3-aminopropyl trimethoxysilane, 4-aminobutyl triethoxysilane, 3-aminopropyl tris(methoxyethoxyethoxy)silane, 11-amino-undecyl triethoxysilane, 3-aminopropylmethyl dimethoxysilane, 3-aminopropyldiisopropyl ethoxysilane, N-(2-aminoethyl)-3-aminopropyl trimethoxysilane, 1,2-bis[(trimethoxysilyl)propyl]ethylenediamine, azidosulfonylhexyl triethoxysilane, bis(trimethoxysilyl) octane, bis(trimethoxysilylpropyl)amine, N-butylaminopropyl trimethoxysilane, 3-chloropropyl triethoxysilane, 3-chloropropyl trimethoxysilane, N-cyclohexylaminopropyl trimethoxysilane, N-ethylaminoisobutyl trimethoxysilane, 3-glycidopropyl trimethoxysilane, 2-(3,4-epoxycyclohexyl)ethyl trimethoxysilane, 2-(3,4-epoxycyclohexyl)ethyl trimethoxysilane, (3-g lycydoxypropyl) triethoxysilane, (3-glycydoxypropyl) trimethoxysilane, hexenyltriethoxysilane, N-(hydroxyethyl)-N-methylaminopropyl trimethoxysilane, bis(2-hydroxyethyl)-3-aminopropyl triethoxysilane, 3-hydroxypropyl trimethoxysilane, 3-isocyanatopropyl triethoxysilane, 3-isocyanatopropyl trimethoxysilane, 3-methacryloxypropyl trimethoxysilane, N-methylaminopropyl trimethoxysilane, 3-mercaptopropyl trimethoxysilane, 3-thioisocyanatopropyl trimethoxysilane, bis(triethoxysilyl)ethane, bis-(trimethoxysilylpropyl)amine, bis-[3-(triethoxysilyl)propyl]tetrasulfide, bis(trimethoxysilylpropyl)amine, 3-(triethoxysilyl)propyl succinic anhydride, ureidopropyl triethoxysilane, ureidopropyl trimethoxysilane, vinyltriacetoxysilane, vinyltriethoxysilane, vinyltrimethoxysilane, and a mixture thereof.

10. The plurality of organometallized layers of claim 8, wherein said reactive polysiloxane is a mono functional polysiloxane, said mono functional polysiloxane is selected from the group consisting asymmetric chlorine terminated polydimethylsiloxane, asymmetric triacetoxysilyl terminated polydimethylsiloxane, asymmetric triethoxysilyl terminated polydimethylsiloxane, asymmetric diethoxymethylsilyl terminated polydimethylsiloxane; asymmetric ethoxydimethylsilyl terminated polydimethylsiloxane, asymmetric trimethoxysilyl terminated polydimethylsiloxane, asymmetric dimethoxymethylsilyl terminated polydimethylsiloxane, asymmetric methoxydimethylsilyl terminated polydimethylsiloxane, mono aminopropyl terminated polydimethylsiloxane, asymmetric mono carbinol hydroxyethoxy terminated polydimethylsiloxane, symmetric mono carbinol hydroxypoly(ethyleneoxy)propyl functional polydimethylsiloxane, asymmetric mono dicarbinol terminated polydimethylsiloxane, symmetric mono carboxy functional polydimethylsiloxane, asymmetric, mono (2,3-epoxy) propylether terminated polydimethylsiloxane, symmetric mono (2,3-epoxy)propylether functional polydimethylsiloxane, asymmetric mono hydride terminated polydimethylsiloxane, asymmetric mono methacryloxypropyl terminated polydimethylsiloxane, symmetric mono methacryloxypropyl functional polydimethylsiloxane, symmetric mono methacryloxypropyl functional poly(trifluoropropylmethyl)siloxane, asymmetric mono vinyl terminated polydimethylsiloxane, symmetric mono vinyl functional polydimethylsiloxane, and a mixture thereof.

11. The plurality of organometallized layers of claim 8, wherein said reactive polysiloxane is a polyfunctional terminated polysiloxane, said polyfunctional terminated polysiloxane is selected from the group consisting of chlorine terminated polydimethylsiloxane, triacetoxysilyl terminated polydimethylsiloxane, triethoxysilyl terminated polydimethylsiloxane, diethoxysilyl terminated polydimethylsiloxane; ethoxysilyl terminated polydimethylsiloxane, trimethoxysilyl terminated polydimethylsiloxane, dimethoxysilyl terminated polydimethylsiloxane, methoxysilyl terminated polydimethylsiloxane, vinyl terminated polydimethylsiloxane, vinyl terminated polydiethylsiloxane, vinylmethylsiloxane-dimethylsiloxane copolymer, poly(vinylmethylsiloxane) homopolymer, hydride terminated poly(methylhydrosiloxane), methylhydrosiloxane-dimethylsiloxane copolymer, polymethylhydrosiloxane, silanol terminated polydimethylsiloxane, silanol terminated polytrifluoropropylmethylsiloxane; hydroxypropyl terminated polydimethylsiloxanes, hydroxyethyoxypropyl terminated polydimethylsiloxane, hydroxyhexyl terminated polydimethylsiloxane, hydroxybutyl terminated polydimethylsiloxane, hydroxyhexyl terminated polydimethylsiloxane, aminopropyl terminated polydimethylsiloxanes, aminohexyl terminated polydimethylsiloxane, alpha, omega-di[(N-ethyl)amino(2-methyl)propyl]polydimethylsiloxane, alpha, omega-di[(N-methyl)amino(2-methyl)propyl]polydimethylsiloxane, epoxypropoxypropyl terminated polydimethylsiloxanes, (epoxypropoxypropyl methylsiloxane)-dimethylsiloxane copolymer, (epoxycyclohexylmethylsiloxane)-dimethylsiloxane copolymer, epoxycyclohexylethyl terminated polydimethylsiloxane, methacryloxypropyl terminated polydimethylsiloxane, 3-acryloxy-2-hydroxypropoxypropyl terminated polydimethylsiloxane, acryloxypropylmethylsiloxane-dimethylsiloxane copolymer, succinic anhydride terminated polydimethylsiloxane, carboxyalkyl terminated polydimethylsiloxane, mercaptopropylmethylsiloxane-dimethylsiloxane copolymer having, chloromethyl terminated polydimethylsiloxane, chloropropylmethylsiloxane-dimethylsiloxane copolymer, and a mixture thereof.

12. A method of making a composite according to claim 1, comprising steps of: (12a) providing said material according to claim 3; (12b) roughening said material according to claim 5; (12c) conducting said surface reaction according claim 8, and (12d) wetting said plurality of organometallized surface layers with said low freezing-point liquid according claim 2.

13. A composite preventing ice adhesion comprises of:
(13a) a material having a plurality of micro-roughened surfaces and
(13b) a low freezing-pint liquid wetting said surfaces.

14. The composite of claim 13, wherein said low freezing-point liquid is a hydrophobic fluid selected from the group consisting of poly(pentamethylcyclopentasiloxane), polydiethylsiloxane, poly(oxytetrafluoroethylene-co-oxydifluoromethylene), polydimethylsiloxane, T-branched polydimethylsiloxane, poly(dimethylsiloxane-co-diethylsiloxane), poly(ethylmethylsiloxane), poly(methyltrifluoropropylsiloxane), poly(methyltrifluoropropylsiloxane-co-dimethylsiloxane), perfluoropolyether, polyhexafluoropropylene oxide, perfluoropolyalkyl ether, perfluoroalkyl ether substituted s-triazine, fluorinated ether, polychlorotrifluoroethylene, polyalphaolefin hydrogenated, polyalphaolefin, perfluoroalkyl silsesquioxane, and a mixture thereof.

15. The composite of claim 13, wherein said material is selected from the group consisting of polymer, interpenetrating polymer network, coating containing polymer, coating containing interpenetrating polymer network, fiber reinforced polymer, laminated polymer, composite polymer, polymer by injection molding, polymer by reaction injection molding, polymer by casting, and a mixture thereof.

16. The composite of claim 15, wherein said polymer is selected from the group consisting of polyurethane, polyurea, fluorinated polyurethane, fluorinated polyurea, polysiloxane, high density polyethylene, low density polyethylene, polyethylene, polyvinyl chloride, chlorinated polyvinyl chloride, polypropylene, polyethylene terephthalate, acrylonitrile-butadiene-styrene, cyclic olefin copolymer, polyoxymethylene, polyacrylonitrile, polybutadiene, polybutylene, polyvinylidene chloride. polyolefin, polyolefin blend, cycloolefin polymer, poly(ethylene-co-propylene), nature polyisoprene, cis-1,4-polyisoprene, trans-1,4-polyisoprene, synthetic polyisoprene, polybutadiene rubber, chloroprene rubber, Neoprene, poly(isobutylene-co-isoprene), chlorobutyl rubber, ethylene propylene rubber, ethylene propylene diene rubber, polypentenamer, polyalkenamer, polyoctenamer, polynorbornene, poly(dicyclopetadiene), polycyclorene rubber, silicone rubber, fluorosilicone rubber, fluoroelastomer, perfluoroelastomer, polypentenomer, alternating rubber, polyolefin blend, oligoethylene, oligopropylene, hydrocarbon resin, and a mixture thereof.

17. The composite of claim 13, wherein said plurality of micro-roughened surfaces is resulted from a roughing means being applied on said material according claim 15, leading to a surface with a preferred surface average roughness (RMS), and said roughing means is selected from the group consisting of laser etching, plasma etching, oxygen plasma etching, blasting with a medium, sanding with a sandpaper, extrusion with a surface roughened mold, molding with a surface roughened mold, casting on a surface roughened mold, and a mixture thereof.

18. A method of making a plurality of microroughened surfaces according claim 17, wherein said preferred surface average roughness (RMS) is between 5 to 25 microns, and more preferred in about 12.3-14.5 microns.

19. A method of making a plurality of microroughened surfaces according claim 17, wherein said medium, said sandpaper, or said surface roughened mold by grit designation is between grit 80 (177-210 microns) to grit 320 (32.5-36 microns), and more preferred in about grit 240 (50.0-53.5 microns).

20. A method of making a composite according to claim 13, comprising steps of: (20a) providing said material according to claim 15, (20b) roughening said material according claim 17, and (20c) wetting said plurality of micro-roughened surfaces with said low freezing-point liquid according claim 14.
